(19) United States
(12) Patent Application Publication
(10) Pub. No.: US 2026/0231920 A1
(43) Pub. Date: Aug. 13, 2026

(54) FISHING REEL

(71) Applicant: Shimano Inc., Osaka (JP)

(72) Inventor: Hirotaka HONDA, Osaka (JP)

(21) Appl. No.: 19/535,654

(22) Filed: Feb. 10, 2026

(30) Foreign Application Priority Data
Feb. 12, 2025 (JP) 2025-021104
Feb. 12, 2025 (JP) 2025-021105

(51) Int. Cl. A01K 89/0155; A01K 89/015; A01K 89/033

(52) U.S. Cl. CPC A01K 89/01555; A01K 89/015; A01K 89/0155; A01K 89/033

(57) ABSTRACT

A fishing reel includes a spool provided on a reel body to be rotatable and to wind up a fishing line, a conductive part provided on the spool, a magnet facing the conductive part, a movable part holding the magnet so as to be movable between a first position located in a first direction that is a direction away from the conductive part, and a second position located in a second direction that is a direction opposite to the first direction. The second position located farther in the second direction than the first position is in the first direction with respect to the conductive part. The movable part movable between the first position and the second position in accordance with rotation of the spool, and a contact part on the movable part contacts the spool when the movable part is located at the second position.

### CROSS-REFERENCE TO RELATED APPLICATIONS

This application claims priority to Japanese Patent Application Nos. 2025-021104 and 2025-021105, filed on Feb. 12, 2025. The entire disclosure of Japanese Patent Application Nos. 2025-021104 and 2025-021105 is hereby incorporated by reference.

### BACKGROUND

### Technical Field

The present disclosure generally relates to a fishing reel. More specifically, the present disclosure relates to a fishing reel comprising a brake unit that suppresses backlash.

### Background Information

When a fishing line is released by casting, the spool around which the fishing line is wound rotates in accordance with the delivery of the fishing line. As a result backlash in the fishing reel can occur when the rotational speed of the spool is faster than the delivery speed of the fishing line during casting. When backlash occurs, the fishing line becomes loose, resulting in line slack, which causes the line to become tangled.

For example, Japanese Laid-Open Patent Application No. 2016-36308 discloses a spool braking device for a fishing reel, in which the spool braking device includes a conductor on the inner circumference of a spool, a movable part that can move toward and away from the conductor, and a magnet provided in the movable part. In this device, eddy currents generated in accordance with the rotation of the spool cause the magnet provided in the movable part to move toward and away from the conductor, thereby adjusting the induction force based on the magnetic force and applying an appropriate braking force to the spool.

### SUMMARY

It has been determined that in the fishing reel braking mechanism of Japanese Laid-Open Patent Application No. 2016-36308, even when the magnet provided in the movable part is brought in the closest position to the conductor, the induction force based on magnetic force does not provide sufficient braking force to the spool, so there is a risk that backlash can occur when casting, for example, a tackle or a lure with a large mass.

Therefore, an object of the present disclosure is to provide a fishing reel that can suppress the occurrence of backlash.

A fishing reel according to the present disclosure comprises a spool provided on a reel body so as to be rotatable and that can wind up a fishing line, and a braking device that brakes rotation of the spool, the braking device having a magnetic induction braking function, and a contact friction braking function.

According to the present disclosure, when sufficient braking force cannot be obtained with the induction force braking function, braking using a frictional force braking function can be added to obtain the necessary and sufficient braking force.

In the fishing reel according to the present disclosure, the braking device has a conductive part provided on the spool, a magnet facing the conductive part, a movable part that holds the magnet so as to be movable between a first position located in a first direction that is a direction away from the conductive part, and a second position located farther in a second direction that is a direction opposite to the first direction than the first position with respect to the conductive part, and that can move between the first position and the second position in accordance with rotation of the spool, and a contact part provided on the movable part and that comes into contact with the spool when the movable part is located at the second position.

According to the present disclosure, the magnetic induction braking function can be configured from a conductive part, a magnet, and a movable part that holds the magnet so as to be movable between a first position and a second position in accordance with the rotation of the spool, and the contact friction braking function can be configured from a contact part that contacts the spool when the movable part is located at the second position. Therefore, it is possible to add braking by the frictional force braking function to the braking force of the induction force braking function.

In the fishing reel according to the present disclosure, another embodiment of the braking device has a magnetic part having a magnetic force and provided in the reel body, a movable part provided on the spool shaft that moves in the axial direction of the spool shaft in accordance with the rotational speed of the spool, a conductive part that is provided on the movable part that moves together with the movable part so as to be capable of moving toward and away from the magnetic part, and a contact part provided on the movable part that moves together with the movable part, so as to be capable of contacting a contacting part provided on the reel body.

According to the present disclosure, it is possible to configure the magnetic induction braking function from a magnetic part, a movable part that moves in the axial direction of the spool shaft, and a conductive part that moves together with the movable part and that can move toward and away from the magnetic part, and to configure the contact friction braking function from a contact part that moves together with the movable part and that can contact a contacting part provided on the reel body. Therefore, it is possible to add braking by the frictional force braking function to the braking force of the induction force braking function.

One embodiment of the present disclosure provides a fishing reel comprising a spool provided on a reel body so as to be rotatable and that can wind up a fishing line, a conductive part provided on the spool, a magnet facing the conductive part, a movable part that holds the magnet so as to be movable between a first position located in a first direction that is a direction away from the conductive part, and a second position located farther in a second direction that is a direction opposite to the first direction than the first position with respect to the conductive part, and that can move between the first position and the second position in accordance with rotation of the spool, and a contact part provided on the movable part and that contacts the spool when the movable part is located at the second position.

According to the present disclosure, in addition to the braking force (hereinafter referred to as induction braking force) of the spool by induction force of a magnet facing the conductive part provided on the spool, it is possible to add the braking force (hereinafter may be referred to as frictional braking force) by frictional force generated as a result of the contact part contacting the spool when the movable part is located at the second position due to eddy currents generated by the rotation of the spool.

In addition, the movable part can have a shaft portion extending along the axial direction of the conductive part, a main body portion having one end that is pivotably supported by the shaft portion and supporting a plurality of the magnets, and a biasing portion that biases the other end of the main body portion in the first direction, and the contact part can be disposed closer to the other end than at least one of the magnets.

According to this configuration, the contact part is arranged closer to the other end of the main body portion, so that the amount of movement of the contact part can be large. Accordingly, since the amount of movement of the contact part can be large, it is possible to control the contact and non-contact of the contact part and the spool.

In addition, the contact part can be disposed on the other end of the main body portion.

According to this configuration, the amount of movement of the contact part can be further increased, and it is possible to control the contact and non-contact of the contact part and the spool.

In addition, the contact part can have an abutting portion that can abut against the spool, and a protruding portion located further in the first direction than the abutting portion and that protrudes further than the abutting portion, and the main body portion can have a first retention portion that can retain and position the protruding portion, and a second retention portion located further in the second direction than the first retention portion and that can retain and position the protruding portion.

According to this configuration, it is possible to prohibit execution of braking using a frictional force when the contact part is positioned at the first retention portion, and it is possible to execute braking using a frictional force when the contact part is positioned at the second retention portion. That is, since it is possible to use the retention positions to switch between braking in which the frictional braking force is added to the induction braking force and braking in which the frictional force is not added, i.e., braking using only induction braking force, the braking force can be easily adjusted.

In addition, the abutting portion can have a central portion along the circumferential direction of the spool and at an end in the second direction that protrudes in the second direction.

According to this configuration, since the abutting portion has a central portion along the circumferential direction of the spool and at an end in the second direction that protrudes in the second direction, the abutting portion can come into surface contact with the spool. Accordingly, since the abutting portion can come into surface contact with the spool, generation of an abnormal noise can be suppressed.

In addition, the abutting portion of the contact part positioned by the second retention portion can protrude in the second direction from the surface of the main body portion in the second direction, and the protrusion amount of the abutting portion in the second direction can be set such that the abutting portion does not contact the spool when the spool starts to rotate as the fishing line is pulled out, and the abutting portion contacts the spool as the rotation speed of the spool increases.

According to this configuration, it is possible to execute braking in which, in addition to the induction braking force of a magnet facing the conductive part provided on the spool, frictional braking force can be added as a result of the contact part contacting the spool when the movable part is located in the second position.

In one embodiment of the present disclosure, a fishing reel according to the present disclosure comprises a spool shaft that is supported by a reel body so as to be rotatable, a spool provided on the spool shaft and can wind up a fishing line, a magnetic part having magnetic force and provided in the reel body, a movable part provided on the spool shaft and movable in the axial direction of the spool shaft in accordance with the rotational speed of the spool, a conductive part that is provided on the movable part and movable together with the movable part so as to be capable of moving toward and away from the magnetic part, and a contact part provided on the movable part and movable together with the movable part so as to be capable of contacting a contacting part provided on the reel body.

According to the present disclosure, because a movable part that is movable in the axial direction of the spool shaft in accordance with the rotational speed of the spool, a conductive part that moves together with the movable part so as to be capable of moving toward and away from the magnetic part, and a contact part that moves together with the movable part so as to be capable of coming into contact with a contacting part provided on the reel body are provided, it is possible to execute, with respect to the spool, friction braking which is contact braking in which there is contact with the spool, in addition to induction braking which is non-contact braking in which there is no contact with the spool. As a result, since braking using both an induction force and a frictional force can be executed with respect to the spool, it is possible to suppress backlash.

In addition, the reel body can include a holding part that holds the magnetic part, and the holding part can have a contacting part that contacts the contact part.

According to the configuration, the contacting part can also serve as a holding part which is a part of the reel body that holds the magnetic part, thereby reducing weight and size.

In addition, the contact part and/or the non-contact part can have a slider.

According to this configuration, the contact part and/or the non-contact part has a slider, so that when the contact part and the contacting part come in contact, generation of an abnormal noise can be suppressed.

In addition, the holding part can have a first holding portion that holds a first magnet portion located on the outer side of the conductive part in the radial direction of the spool, and a second holding portion that holds a second magnet portion located on the inner side of the conductive part in the radial direction of the spool and faces the first magnet portion, and the contact part can have a first contact portion that can contact the first holding portion, and a second contact portion that can contact the second holding portion.

According to this configuration, the contact part has a first contact portion that can contact the first holding portion, which is a contacting part, and a second contact portion that can contact the second holding portion, which is a contacting part, so that the frictional force can be increased compared to a case in which the contact part is a single structure. Accordingly, since the frictional force can be increased, he occurrence of backlash can be further suppressed.

According to the present disclosure, in addition to non-contact braking using induction force of a magnet, it is possible to add braking using a frictional force caused by the contact part coming into contact with the spool, thereby providing a fishing reel that can suppress occurrence of backlash.

### BRIEF DESCRIPTION OF THE DRAWINGS

FIG. 1 is a perspective view of a fishing reel according to a first embodiment of the present disclosure.

FIG. 2 is a cross-sectional view of a fishing reel according to the first embodiment of the present disclosure.

FIG. 3 is a cross-sectional view of a braking device according to the first embodiment of the present disclosure.

FIG. 4 is a perspective view of a movable unit according to the first embodiment of the present disclosure.

FIG. 5 is a front view of the movable unit when a movable part according to the first embodiment of the present disclosure moves to a second position.

FIG. 6 is a front view of the movable unit when the movable part according to the first embodiment of the present disclosure moves to a first position.

FIG. 7 is a perspective view of a contact part retained by a second retention portion according to the first embodiment of the present disclosure.

FIG. 8 is a perspective view of the contact part retained by a first retention portion according to the first embodiment of the present disclosure.

FIG. 9 is a graph showing the correlation between the braking force and the elapsed time from the start of releasing of a fishing line according to the first embodiment of the present disclosure.

FIG. 10 is a front view showing a modified example of the movable part according to the first embodiment of the present disclosure.

FIG. 11 is a schematic diagram showing a partial cross section of a fishing reel according to a second embodiment of the present disclosure.

FIG. 12 is a cross-sectional view of a spool and a braking device in a non-braking state according to embodiment 1 of the second embodiment of the present disclosure.

FIG. 13 is a cross-sectional view of a spool and a braking device in a frictional force braking state according to embodiment 1 of the second embodiment of the present disclosure.

FIG. 14 is a diagram of a braking device in a non-braking state according to embodiment 2 of the second embodiment of the present disclosure.

FIG. 15 is a diagram showing a braking device in a frictional force braking state according to embodiment 2 of the second embodiment of the present disclosure.

FIG. 16 is a diagram of a braking device in a non-braking state according to embodiment 3 of the second embodiment of the present disclosure.

FIG. 17 is a diagram of a braking device in a braking state according to embodiment 3 of the second embodiment of the present disclosure.

FIG. 18 is a diagram of a braking device in a non-braking state according to embodiment 4 of the second embodiment of the present disclosure.

FIG. 19 is a diagram of a braking device in a braking state according to embodiment 4 of the second embodiment of the present disclosure.

FIG. 20 is a cross-sectional view of a braking device according to a modified example of the second embodiment of the present disclosure.

### DETAILED DESCRIPTION

A first embodiment of a fishing reel according to the present disclosure will be described below with reference to the drawings. Identical or corresponding parts in the drawings have been assigned the same reference numerals, and explanations thereof are not repeated.

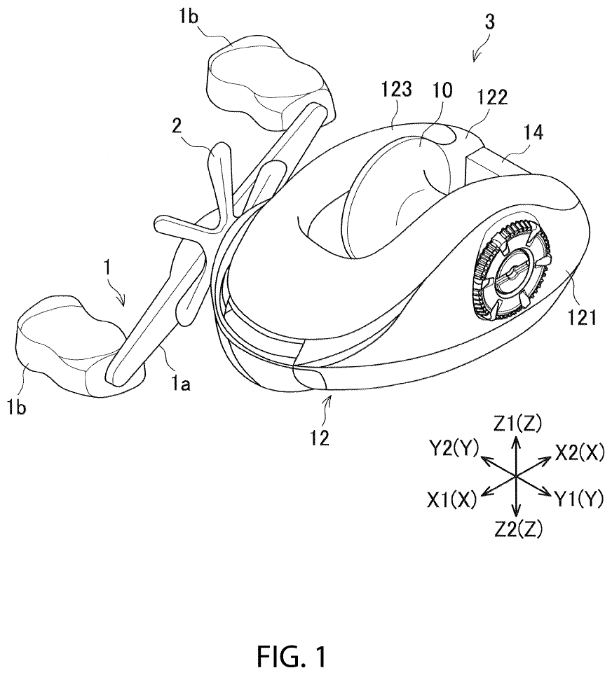

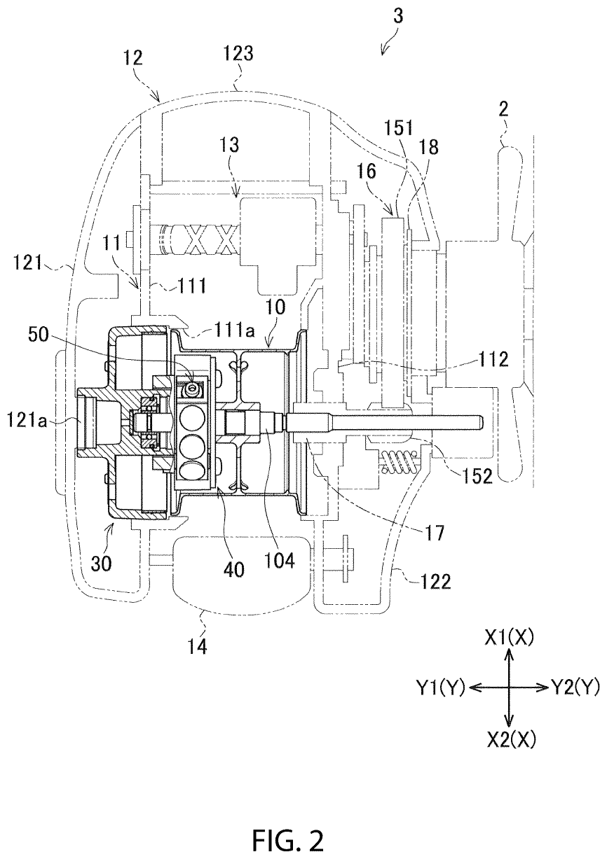

The underlying technology of the fishing reel according to one embodiment of the present disclosure will be described with reference to FIGS. 1 and 2. FIG. 1 is a perspective view of a fishing reel according to a first embodiment of the present disclosure. FIG. 2 is a cross-sectional view of the fishing reel according to the first embodiment of the present disclosure. This fishing reel is, for example, a dual-bearing reel that is used mainly for lure fishing. As shown in FIGS. 1 and 2, the fishing reel comprises a handle 1, a star drag 2, and a reel body 3.

The handle 1 is configured to carry out an operation to wind the fishing line. The handle 1 is arranged on the side of the reel body 3. The handle 1 has a plate-shaped arm 1a having a rotational shaft in the center in the longitudinal direction, and a pair of grips 1b mounted to both ends of the arm 1a so as to be freely rotatable. When the handle 1 is turned, a spool 10 described further below is rotated, thereby winding up the fishing line.

The star drag 2 is adjusted so that a certain level or more tension will not be applied, so that the fishing line will not break when a fish, etc., is caught. The star drag 2 is arranged coaxially with the handle 1 and is positioned between the handle 1 and the reel body 3.

The reel body 3 can be mounted on a fishing rod. The reel body 3 comprises the spool 10, a frame 11, a cover 12, and a clutch operation lever 14. The reel body 3 further comprises, inter alia, a gear mechanism 16, a clutch mechanism 17, a drag mechanism 18, a level winding mechanism 13, and a braking device 30.

The spool 10 is configured so as to be capable of winding up the fishing line. The spool 10 is provided to the reel body 3 so as to be rotatable about an axis. The spool 10 is, for example, made of an aluminum alloy, and is a non-magnetic electrical conductor. The material of the spool 10 is not limited to an aluminum alloy. The material of the spool 10 can be selected from various materials as long as the material is a non-magnetic electrical conductor. The spool 10 includes a body portion 101, a flange portion 102, a boss portion 103, and a spool shaft 104. The spool 10 is, for example, integrally molded.

A fishing line can be wound around the outer circumferential portion of the body portion 101. The body portion 101 is formed in a cylindrical shape having a uniform diameter. The cylindrical boss portion 103 extending in the axial direction is integrally provided on the inner circumferential portion of the body portion 101. A pair of the flange portions 102 are provided. The pair of flange portions 102 respectively extend from both ends of the body portion 101 axially outward and radially outward. The spool shaft 104 is fixed to the boss portion 103 and rotates in synchronization with the body portion 101. The spool shaft 104 extends through the boss portion 103. The spool shaft 104 is fixed to the boss portion 103, for example by serration coupling, so as not to rotate relative to the body portion 101.

The frame 11 supports each component member, such as the handle 1 and the spool 10. The frame 11 has a first frame 111 and a second frame 112. The first frame 111 and the second frame 112 are plate-like member that are arranged facing each other across the spool 10. The first frame 111 and the second frame 112 are respectively perpendicular to the direction in which the spool shaft 104 extends. Hereinbelow, in a state in which the fishing reel is mounted on a fishing rod, the direction in which the tip of the fishing rod faces is referred to as forward X1, the opposite direction is referred to as rearward X2, and the front-rear direction is referred to as X. The direction from the spool 10 toward the handle 1 is referred to as rightward Y2, the opposite direction is referred to as leftward Y1, and the left-right direction is referred to as Y. In addition, in the up-down direction Z that is perpendicular to the front-rear direction X and the left-right direction Y, upward is referred to as Z1 and downward is referred to as Z2.

The cover 12 forms an outer wall of the reel body 3. The cover 12 includes a first cover 121, a second cover 122, and a thumb rest 123.

The first cover 121 forms the left side wall of the reel body 3. The first cover 121 is supported by the first frame 111 and is positioned leftward Y1 of the first frame 111. The first cover 121 has a boss portion 121a. The boss portion 121a extends rightward Y2 from the right surface of the first cover 121.

The second cover 122 forms the right side wall of the reel body 3. The second cover 122 is supported by the second frame 112 and is positioned rightward Y2 of the second frame 112.

The thumb rest 123 forms an upper wall of the reel body 3. The thumb rest 123 is disposed in an area forward X1 of the spool 10, an area leftward Y1 of the left end of the spool 10, and an area rightward Y2 of the right end of the spool 10. Specifically, the thumb rest 123 is disposed so as to surround the periphery of the spool 10 except for rearward X2 of the spool 10.

The level winding mechanism 13 is a mechanism for evenly winding the fishing line around the spool 10. The level winding mechanism 13 moves in the left-right direction, forward X1 of the spool 10. The level winding mechanism 13 is disposed forward X1 of the spool 10 between the first frame 111 and the second frame 112.

The clutch operation lever 14 operates the clutch mechanism 17 between the handle 1 and the spool 10. The clutch operation lever 14 is disposed rearward X2 of the spool 10, and is configured so as to be able to swing in the up-down direction Z. The clutch operation lever 14 has a thumb rest portion in the middle in the left-right direction Y to be used when carrying out thumbing.

As shown in FIG. 2, the gear mechanism 16, the clutch mechanism 17, and the drag mechanism 18 are located between the second frame 112 and the second cover 122.

The gear mechanism 16 transmits the rotational force from the handle 1 to the spool 10 and the level winding mechanism 13. The gear mechanism 16 is disposed between the spool shaft 104 and the level winding mechanism 13 in the front-rear direction X.

The clutch mechanism 17 switches the connection between the handle 1 and the spool 10. The rotation of the handle 1 is transmitted to the spool shaft 104 via a drive gear 151, a pinion gear 152, and the clutch mechanism 17. The clutch mechanism 17 carries out engagement or disengagement in accordance with an operation of the clutch operation lever 14. The clutch mechanism 17 can be disengaged by operating the clutch operation lever 14. When the handle 1 is rotated in the winding direction in a state in which the clutch mechanism 17 is disengaged, the clutch mechanism 17 is configured to return to the engaged state.

The drag mechanism 18 applies a braking force for braking the spool 10 when the fishing line is pulled out in the line delivering direction when a fish is hooked. The drag mechanism 18 has a drag washer, or the like. The drag mechanism 18 presses the drag washer by operation of the star drag 2 and adjusts the frictional force of the drag washer, or the like, thereby adjusting the braking force applied to the spool 10.

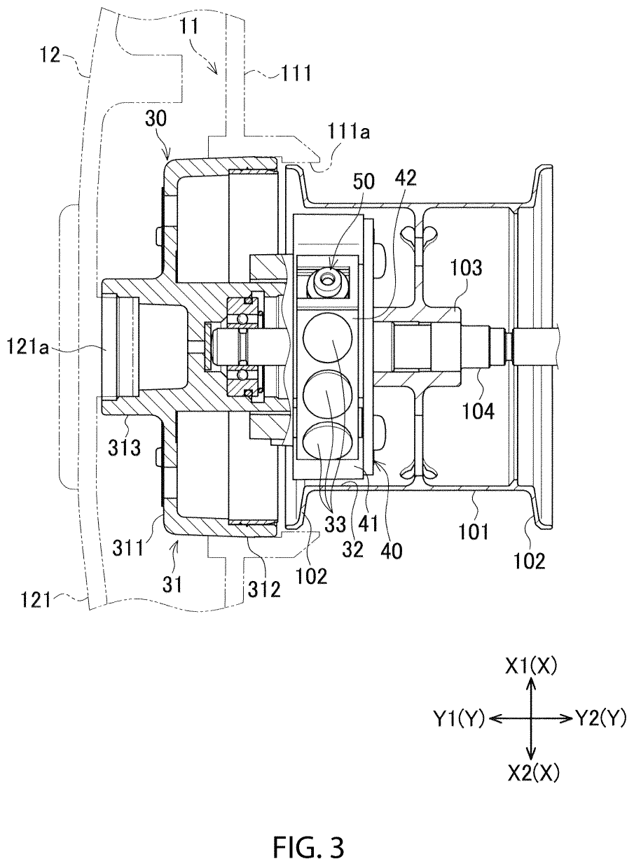

The braking device 30 will be described next with reference to FIG. 3. FIG. 3 is a cross-sectional view of the braking device 30 according to the first embodiment of the present disclosure. FIG. 3 is a cross-sectional view of a plane that is perpendicular to the up-down direction Z and that passes through the axis of the spool 10, excluding a movable unit 40. When casting in a state in which the clutch mechanism 17 is disengaged, the spool 10 rotates freely, releasing the fishing line, which has the risk of backlash occurring. The braking device 30 is configured to brake the rotation of the spool 10 to suppress the occurrence of backlash. The braking device 30 brakes the rotation of the spool 10 using an induction force braking function and a frictional force braking function. The induction force braking function is a braking function that applies induction force to the spool 10, and the frictional force braking function is a braking function that applies frictional force to the spool 10. At least a portion of the braking device 30 is disposed between the first frame 111 and the first cover 121. As shown in FIG. 3, the braking device 30 comprises a case 31, a conductive part 32, a magnet 33, the movable unit 40, and a contact part 50.

The case 31 connects the braking device 30 to the first cover 121. The case 31 blocks an opening 111a formed in the first frame 111. The case 31 has an annular portion 311, an outer cylindrical portion 312, and an inner cylindrical portion 313. The case 31 is, for example, integrally formed by a metal material. The case 31 can be integrally formed from synthetic resin as long as at least a standard level of rigidity can be ensured.

The annular portion 311 is an annular plate member that is perpendicular to the left-right direction Y. The annular portion 311 opposes the leftward Y1 side portion of the movable unit 40. The annular portion 311 is connected to a connecting portion formed on the first cover 121 via a plurality of connecting members.

The outer cylindrical portion 312 extends rightward Y2 from the outer peripheral edge of the annular portion 311. The axis of the outer cylindrical portion 312 is disposed coaxially with the spool 10. The right side end of the outer cylindrical portion 312 faces the left side end of the flange portion 102 on the left side. The right side end of the outer cylindrical portion 312 blocks the opening 111a of the first frame 111.

The inner cylindrical portion 313 extends leftward Y1 and rightward Y2 from the outer peripheral edge of the annular portion 311 The axis of the inner cylindrical portion 313 is disposed coaxially with the spool 10. The left side end of the inner cylindrical portion 313 is fitted over the boss portion 121a extending rightward Y2 from the first cover 121. The right side end of the inner cylindrical portion 313 extends further rightward Y2 than the right side end of the outer cylindrical portion 312. The left side portion of the spool shaft 104 extending in the left-right direction Y is inserted into the inner cylindrical portion 313. As a result, the right side end of the inner cylindrical portion 313 supports the left side end of the spool shaft 104 so as to be freely rotatable via a bearing member. The middle portion of the spool shaft 104 is supported by the second frame 112 via a bearing member, and the right side end of the spool shaft 104 is supported by the second cover 122 via a bearing member.

The conductive part 32 generates an eddy current due to magnetic flux of the magnet 33. Since the spool 10 is made of aluminum alloy, which is a non-magnetic electrical conductor, in the present embodiment, the inner circumferential portion of the spool 10 (body portion 101) corresponds to the conductive part 32. The conductive part 32 is not limited to being the same as the spool 10. If the spool 10 is not an electrical conductor, such as being made of hard resin, a conductive part 32 that is an electrical conductor may be separately provided on the inner circumferential portion of the spool 10. In addition, the conductive part 32 is not limited to a cylindrical shape as long as the conductive part 32 can generate an eddy current.

The magnet 33 is, for example, a plurality of permanent magnets. The plurality of magnets 33 are arranged in positions along the circumferential direction around the axis of the spool 10, at positions facing the inner circumferential portion (conductive part 32) of the spool 10. Each of the magnets 33 is formed, for example, in a disk shape, with the N pole disposed on one side and the S pole disposed on the other side. The plurality of magnets 33 are arranged so that the N pole and the S pole alternate in the circumferential direction. The arrangement of the magnets 33 can start from either the N pole or the S pole, as long as the poles are alternately arranged.

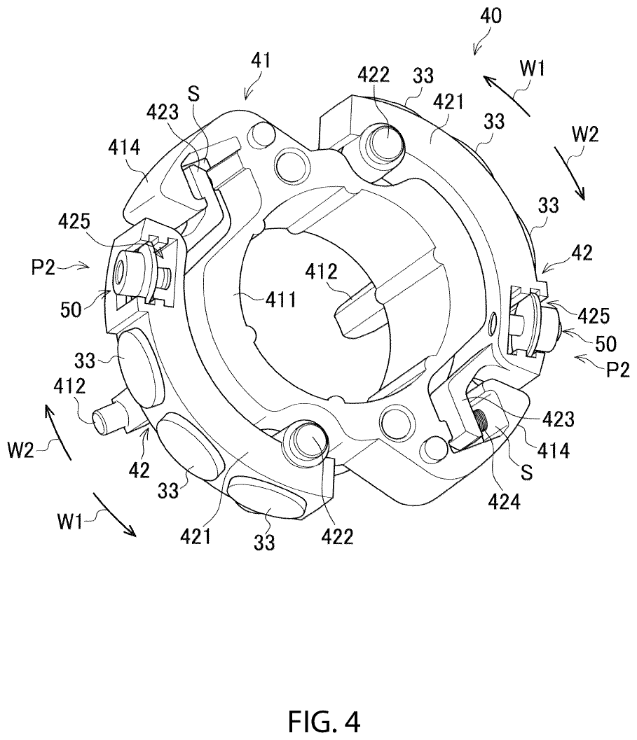

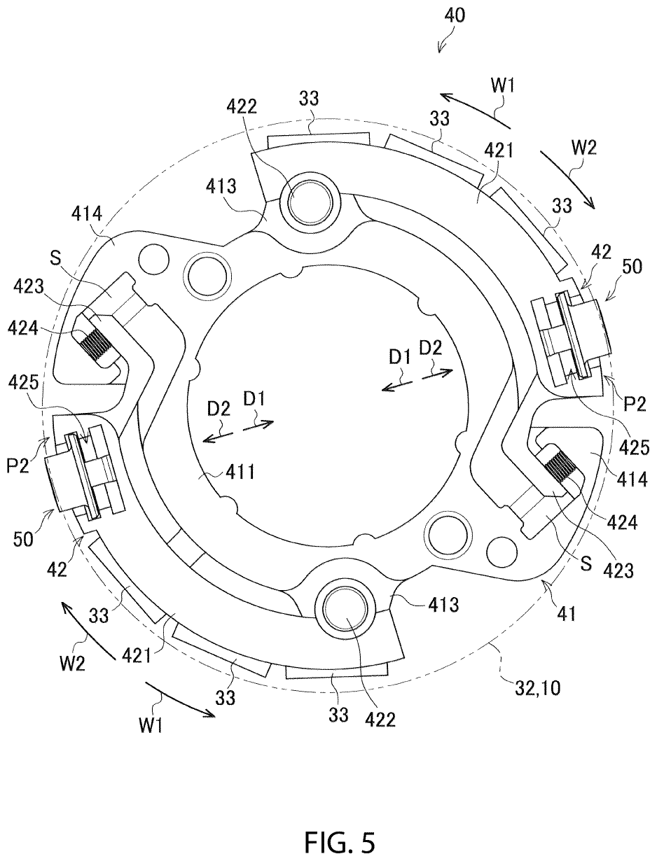

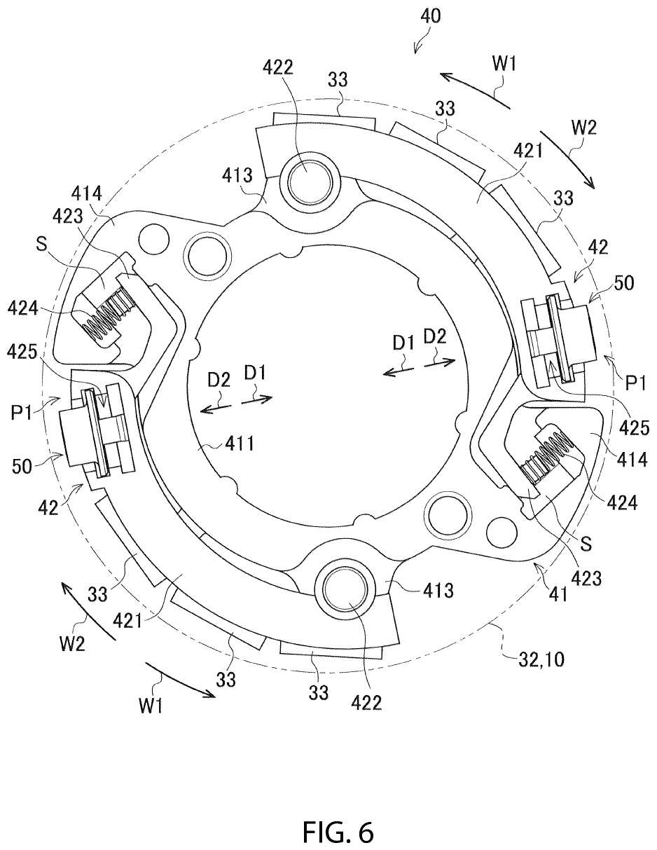

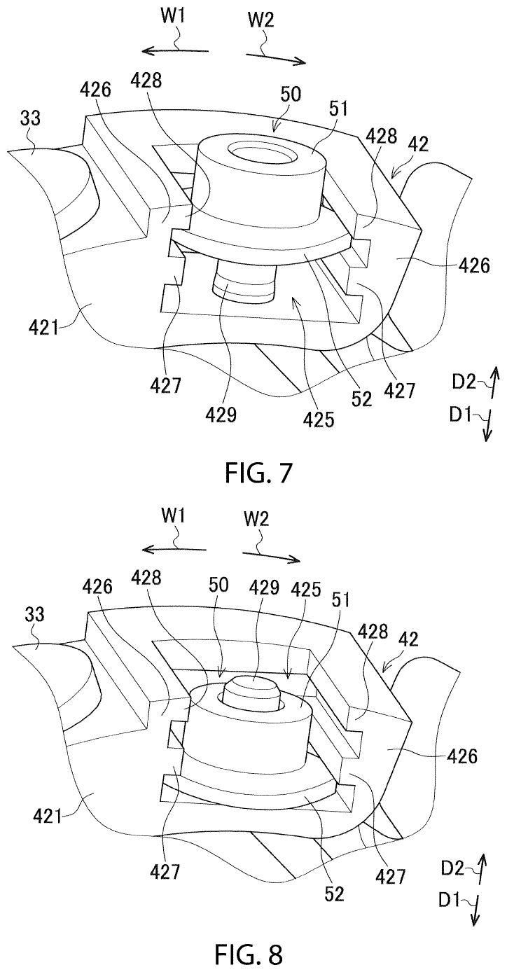

The movable unit 40 will be described next with reference to FIGS. 3 to 8. FIG. 4 is a perspective view of the movable unit 40 according to the first embodiment of the present disclosure. FIG. 5 is a front view of the movable unit 40 when a movable part 42 according to the first embodiment of the present disclosure moves to the second position P2. FIG. 6 is a front view of the movable unit 40 when the movable part 42 according to the first embodiment of the present disclosure moves to the first position P1. FIG. 7 is a perspective view of the contact part 50 retained by a second retention portion 428 according to the first embodiment of the present disclosure. FIG. 8 is a perspective view of the contact part 50 retained by a first retention portion 427 according to the first embodiment of the present disclosure. The movable unit 40 is a mechanism that pivotably supports the plurality of magnets 33 and the contact part 50. In the following description, as viewed from the movable part 42, the (radially inward) direction away from the conductive part 32 is referred to as the first direction D1 and the direction opposite to the first direction D1 is referred to as the second direction D2. In addition, the position in the first direction D1 with respect to the conductive part 32 is referred to as the first position P1, and the position in the second direction D2 of the first position P1 with respect to the conductive part 32 is referred to as the second position P2. As shown in FIGS. 4 to 6, the movable unit 40 has a cylindrical part 41 and a movable part 42.

The cylindrical part 41 supports the movable part 42. The cylindrical part 41 is formed in a cylindrical shape that is coaxial with the spool 10, and the left side portion thereof is surrounded by the case 31. The cylindrical part 41 has a cylindrical main body 411, a leg portion 412, a shaft support portion 413, and a locking portion 414.

The cylindrical main body 411 has the same axis as the axis of the spool 10. The cylindrical main body 411 has a columnar shape on the radially inner side of the spool 10. The left side portion of the spool shaft 104 is inserted into the space of the cylindrical main body 411. The cylindrical main body 411 is disposed at a position facing the left end portion of the body portion 101. The shaft support portion 413 and the locking portion 414 are arranged on the outer periphery of the cylindrical main body 411. Hereinbelow, the radially inner side of the spool 10 and the radially outer side of the spool 10 can simply be referred to as the radially inner side and the radially outer side.

The leg portion 412 fixes the cylindrical part 41 to the case 31. For example, a pair of the leg portions 412 are provided in the front and back. The pair of leg portions 412 are positioned diametrically opposite each other at the left end outer periphery of the cylindrical main body 411. The pair of leg portions 412 respectively extend in the axial direction from the left end portion of the cylindrical main body 411. The left end portions of the pair of leg portions 412 are respectively provided with protrusions that protrude radially outward, and these protrusions are fixed to the case 31.

The shaft support portion 413 supports the movable part 42 so as to be able to swing. For example, a pair of the shaft support portions 413 are provided above and below. The pair of shaft support portions 413 respectively protrude radially outward from the cylindrical main body 411 at the intermediate portion in the left-right direction Y.

The locking portion 414 limits the swinging of the movable part 42. Specifically, the locking portion 414 limits, through the relationship with an engagement portion 423 described further below, the movement of the movable part 42 in the radially outward direction so as not to exceed a prescribed amount. For example, a pair of the locking portions 414 are provided above and below. The pair of locking portions 414 respectively protrude radially outward from the cylindrical main body 411 at the right end portion of the cylindrical main body 411. The pair of locking portions 414 each have a space S.

The shaft support portion 413 and the locking portion 414 are provided to respectively correspond to first and second ends of the movable part 42. Accordingly, a pair of the movable parts 42 are arranged on and along the outer periphery of the cylindrical main body 411. Specifically, the pair of movable parts 42 are arranged point-symmetrically with respect to the rotational center of the spool 10. The leg portion 412 is provided corresponding to the intermediate position between the shaft support portion 413 and the locking portion 414. The space S of the locking portion 414 is opened in the circumferential direction toward the corresponding shaft support portion 413. In the following description, in the circumferential direction of the cylindrical main body 411, the direction from the first end of the movable part 42 in the circumferential direction toward the second end of the movable part 42 in the circumferential direction is referred to as other end direction W2, and the opposite direction is referred to as one end direction W1.

The movable part 42 swings in the radial direction of the cylindrical part 41. Specifically, the movable part 42 swings about the axis of a shaft portion 422 supported by the cylindrical part 41. The movable part 42 extends along the outer periphery of the cylindrical main body 411, and a pair (two) thereof are provided on the outer periphery of the cylindrical main body 411. An end of the movable part 42 in the first end direction W1 of the circumferential direction is supported by the shaft support portion 413, and the end in the second end direction W2 of the circumferential direction is locked by the locking portion 414. The movable part 42 has a main body portion 421, a shaft portion 422, an engagement portion 423, a biasing portion 424, and a housing portion 425 (refer to FIG. 7).

The main body portion 421 swings about the shaft portion 422. For example, the main body portion 421 is formed of synthetic resin and has a prescribed elastic modulus. The main body portion 421 is formed in an arc shape along the outer periphery of the cylindrical main body 411. The main body portion 421 supports a plurality of the magnets 33 and a single contact part 50 on the radially outer side. The plurality of magnets 33 are, for example, three magnets 33. The number of the magnets 33 can be one, or four or more. The number of the contact parts 50 can be two or more.

The shaft portion 422 supports the main body portion 421 so as to be able to swing. The shaft portion 422 is provided at a one end direction W1 end of the movable part 42. The shaft portion 422 extends along the axial direction of the conductive part 32. Specifically, the shaft portion 422 is fixed to the shaft support portion 413 and extends from the shaft support portion 413 in the direction opposite to the case 31. The main body portion 421 swings in the first direction D1 or the second direction D2 about the shaft portion 422 When the main body portion 421 is provided radially inward of the conductive part 32, the first direction D1 is the radially inner side and the second direction D2 is the radially outer side. When the main body portion 421 is provided radially outward of the conductive part 32, the first direction D1 is the radially outer side and the second direction D2 is the radially inner side.

The engagement portion 423 engages with the locking portion 414. The engagement portion 423 extends from the second end direction W2 end of the main body portion 421 in the second end direction W2, and enters the space S of the locking portion 414 When the main body portion 421 rotates maximally in the first direction D1 around the shaft portion 422, the second end direction W2 portion of the engagement portion 423 contacts the cylindrical main body 411. When the main body portion 421 rotates maximally in the second direction D2 around the shaft portion 422, the first end direction W1 portion of the engagement portion 423 contacts the locking portion 414.

The biasing portion 424 biases the engagement portion 423 in the first direction D1. The biasing portion 424 is disposed inside the space S and is fixed to a second direction D2 side wall surface of the locking portion 414. As a result, the biasing portion 424 extends in a state in which the spool 10 is not being rotated, so that the movable part 42 is located at the first position P1 which is the position on the first direction D1 side. In addition, the biasing portion 424 contracts in a state in which the spool 10 is rotating at a high speed, so that the movable part 42 is located at the second position P2 which is the position on the second direction D2 side. That is, the movable part 42 movably holds the magnets 33 between the first position P1 and the second position P2 in accordance with the rotation of the spool 10, and moves between the first position P1 and the second position P2.

As shown in FIGS. 7 and 8, the housing portion 425 houses the contact part 50. The housing portion 425 is located closer to the other end of the main body portion 421 in the circumferential direction than at least one of the magnets 33. In the present embodiment, the housing portion 425 is located closer to the other end of the main body portion 421 in the circumferential direction than all of the magnets 33. The housing portion 425 has a vertical wall 426, a first retention portion 427, a second retention portion 428, and a column portion 429.

A pair of the vertical walls 426 are provided at the first end direction W1 end and the second end direction W2 end of the housing portion 425. The pair of vertical walls 426 protrude from the surface of the main body portion 421 in the second direction D2, and face each other in the circumferential direction.

A pair of the first retention portions 427 are provided at the middle portions of the pair of vertical walls 426. The pair of first retention portions 427 retain the contact part 50. The pair of first retention portions 427 extend from the pair of vertical walls 426 in the circumferential direction so as to face each other and approach each other. When the pair of first retention portions 427 are retaining the contact part 50, only the induction force braking function can be executed.

A pair of the second retention portions 428 are provided at the second direction D2 ends of the pair of vertical walls 426. The pair of second retention portions 428 retain the contact part 50. The pair of second retention portions 428 extend from the pair of vertical walls 426 in the circumferential direction so as to face each other and approach each other. When the pair of second retention portion 428 are retaining the contact part 50, the induction force braking function and the frictional force braking function can be executed.

The column portion 429 defines the axial and circumferential positions of the contact part 50. The column portion 429 is formed in a columnar shape, and extends in the second direction D2 from the radial surface of the main body portion 421. As shown in FIG. 7, when the contact part 50 is retained by the second retention portion 428, the second direction D2 (radially outward) end of the column portion 429 is located further in the first direction D1 (radially inward) than the second direction D2 end of the contact part 50. As shown in FIG. 8, when the contact part 50 is retained by the first retention portion 427, the second direction D2 (radially outward) end of the column portion 429 is located further in the second direction D2 (radially outward) than the second direction D2 end of the contact part 50. Since the main body portion 421 has a prescribed elastic modulus, it is possible to forcibly change the distance between the pair of first retention portions 427 or the pair of second retention portions 428 that face each other. As a result, engagement and disengagement of the contact part 50 with respect to the main body portion 421 becomes easy.

As shown in FIGS. 3 to 8, the contact part 50 exhibits a frictional force braking function. Specifically, the contact part 50 comes in contact with the spool 10 when the contact part 50 is retained by the second retention portion 428 and the movable part 42 is located at the second position P2. The contact part 50 is provided to the movable part 42. After the conductive part 32 and the magnet 33 cooperate to exhibit an induction force braking function, the contact part 50 exhibits a frictional force braking function. The contact part 50 is disposed closer to the other end of the main body portion 421 in the circumferential direction than at least one of the magnets 33. In the present embodiment, the contact part 50 is located closer to the other end of the main body portion 421 in the circumferential direction than all of the magnets 33. In other words, the contact part 50 is disposed at the other end direction W2 end of the main body portion 421. A columnar space is formed at the center of the contact part 50. The column portion 429 is inserted into the columnar space of the contact part 50, thereby positioning the contact part 50. The contact part 50 has an abutting portion 51 and a protruding portion 52.

The abutting portion 51 abuts against the inner periphery of the spool 10 in a state in which the abutting portion 51 is retained by the second retention portion 428 and the movable part 42 is located at the second position P2. The column portion 429 extending from the outer periphery of the main body portion 421 is inserted into the abutting portion 51. The abutting portion 51 has a central portion in the circumferential direction of the spool 10 and at an end in the second direction D2 that protrudes in the second direction D2. Specifically, the second direction D2 end of the abutting portion 51 is formed along the inner periphery of the spool 10. As a result, the second direction D2 end of the abutting portion 51 slides with respect to the inner periphery of the spool 10 in a surface contact state. When the protruding portion 52 is being retained by the first retention portion 427, the second direction D2 end of the abutting portion 51 does not protrude in the second direction D2 from the second direction D2 end of the main body portion 421. When the protruding portion 52 is being retained by the second retention portion 428, the second direction D2 end of the abutting portion 51 protrudes in the second direction D2 from the second direction D2 end of the main body portion 421. In the present embodiment, the protrusion amount of the abutting portion 51 in the second direction D2 is set such that the abutting portion 51 does not contact the spool 10 when the spool 10 starts to rotate as the fishing line is pulled out, and the abutting portion 51 comes into contact with the spool 10 as the rotation speed of the spool 10 increases. In addition, the abutting portion 51 is, for example, made of synthetic resin.

The protruding portion 52 is located further in the first direction D1 than the abutting portion 51 and protrudes further in the circumferential direction than at least the abutting portion 51. The protruding portion 52 is retained by the first retention portion 427 and the second retention portion 428. Specifically, when the protruding portion 52 is being retained by the first retention portion 427, the abutting portion 51 is stored inside the housing portion 425. That is, when the protruding portion 52 is being retained by the first retention portion 427, even if the movable part 42 is located at the second position P2, the abutting portion 51 does not abut against the spool 10. On the other hand, when the protruding portion 52 is being retained by the second retention portion 428, the abutting portion 51 protrudes radially outward from the housing portion 425. That is, if the protruding portion 52 is being retained by the second retention portion 428, when the movable part 42 is located at the second position P2, the abutting portion 51 abuts against the spool 10.

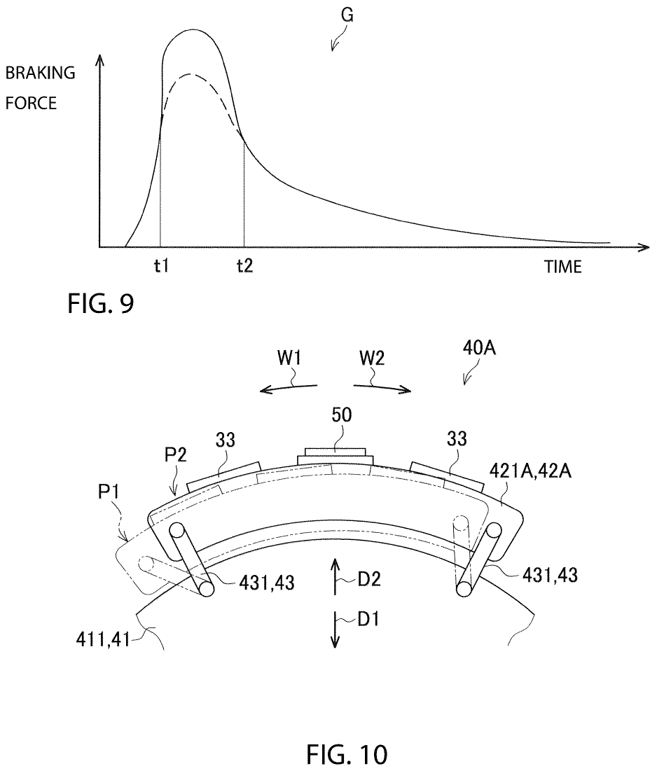

The operation of the fishing reel will be described next with reference to FIG. 9. FIG. 9 is a graph G showing the correlation between the braking force and the elapsed time from the start of releasing a fishing line according to the first embodiment of the present disclosure.

A case in which the induction force braking function is executed will be described. When the contact part 50 is being retained by the first retention portion 427, the fishing reel executes only the induction force braking function. As indicated by the broken line in the graph of FIG. 9, prior to casting, the braking force that acts on the spool 10 is zero. When the spool 10 is rotated by a casting operation, an eddy current corresponding to the rotation speed of the spool 10 is generated due to the magnetic flux of the magnet 33 that faces the conductive part 32 (spool 10). The eddy current causes an induction force to act on the spool 10 in the direction opposite to the rotation direction. As a result, the braking force increases and the spool 10 is braked. The first position P1 is set in advance to a position in which an eddy current can be generated by the rotation of the spool 10.

In addition, the magnet 33 is pulled in the rotation direction of the spool 10 by a reaction force of the induction force caused by the magnet 33 due to the rotation of the spool 10 (movement of the surface of the conductive part 32). As a result, the movable part 42 is pulled toward the rotation surface of the conductive part 32 (spool 10) with the shaft portion 422 serving as the fulcrum, against the biasing force of the biasing portion 424. As the movable unit 40 approaches the spool 10, the magnetic flux linking the conductive part 32 increases. As a result, the rate of change of the magnetic flux of the spool 10 increases in the rotational circumferential direction. In particular, since the polarities of the magnetic poles of adjacent magnets 33 are different, the rate of change of the magnetic flux in the rotational circumferential direction increases further. That is, as the movable part 42 approaches the rotation surface of the spool 10, the induction force increases and the braking force increases. As the fishing line hits the water, the braking force reaches a peak after time t1, after which the braking force decreases with the passage of time.

A case in which the frictional force braking function is executed in addition to the induction force braking function will be described next. When the contact part 50 is retained by the second retention portion 428, the fishing reel executes the induction force braking function and the frictional force braking function. Although the retention position of the contact part 50 can be manually switched, in general, retention by the second retention portion 428 is standard. As indicated by the solid line in the graph of FIG. 9, prior to casting, the braking force that acts on the spool 10 is zero. When the spool 10 is rotated by a casting operation, an eddy current corresponding to the rotation speed of the spool 10 is generated due to the magnetic flux of the magnet 33 that faces the conductive part 32. The eddy current causes an induction force to act on the spool 10 in the direction opposite to the rotation direction. As a result, the braking force increases and the spool 10 is braked.

In addition, due to a reaction force of the induction force caused by the magnet 33 due to the rotation of the spool 10, the magnet 33 is conversely pulled in the rotation direction of the spool 10. As a result, the movable part 42 is pulled toward the rotation surface of the conductive part 32 with the shaft portion 422 serving as the fulcrum, against the biasing force of the biasing portion 424. As the movable part 42 approaches the spool 10, the magnetic flux linking the conductive part 32 increases. As a result, the rate of change of the magnetic flux of the spool 10 increases in the rotational circumferential direction. That is, as the movable part 42 approaches the rotation surface of the spool 10, the induction force increases and the braking force increases.

Since the contact part 50 is retained by the second retention portion 428, when the movable part 42 reaches the position at which the movable part 42 reaches the second position P2, the abutting portion 51 comes in contact with the inner circumferential surface of the spool 10. In the present embodiment, the abutting portion 51 is adjusted to come in contact with the spool 10 when time t1 has elapsed since the start of casting. Since the abutting portion 51 comes into sliding contact with the inner circumferential surface of the spool 10, braking force caused by friction is applied to the spool 10. As a result, after time t1, during the first half of so-called high-speed rotation of the spool 10, braking force caused by frictional force based on the reaction force of the induction force acts on the spool 10, in addition to the braking force caused by induction force based on magnetic force. Accordingly, after time t1, it is possible to obtain a greater braking force compared to a case in which only braking force caused by induction force is applied, indicated by the broken line.

The braking force reaches a peak after time t1, after which the induction force decreases as the rotational speed of the spool 10 decreases. When the induction force decreases, the movable part 42 is separated from the rotation surface of the conductive part 32 by the biasing force of the biasing portion 424. In the present embodiment, the abutting portion 51 is adjusted to separate from the spool 10 when time t2 has elapsed since the start of casting. As a result, after time t2, only the braking force caused by induction force acts on the spool 10, and thereafter, the braking force decreases with the passage of time.

According to the configuration described above, if the movable part 42 has not reached the second position P2, the eddy current that is generated by the rotation of the spool 10 can ensure a braking force (hereinafter may be referred to as induction braking force) of the spool 10 by the induction force caused by the magnet 33 that faces the conductive part 32 provided in the spool 10, and it is possible to execute induction force braking by applying induction braking force to the spool 10. When the movable part 42 is located at the second position P2, the eddy current that is generated by the rotation of the spool 10 can ensure a braking force (hereinafter may be referred to as frictional braking force) of the spool 10 by frictional force caused by the contact part 50 coming in contact with the spool 10, and it is possible to execute frictional force braking that applies frictional braking force to the spool 10 in addition to the induction braking force.

In addition, the movable part 42 can have the shaft portion 422 extending along the axial direction of the conductive part 32, the main body portion 421 having one end that is pivotably supported by the shaft portion 422 and supporting a plurality of the magnets 33, and the biasing portion 424 that biases the other end of the main body portion 421 in the first direction D1, and the contact part 50 may be disposed closer to the other end than at least one of the magnets 33. According to said configuration, the contact part 50 is arranged closer to the other end of the main body portion 421, so that the amount of movement of the contact part 50 becomes large. Accordingly, since the amount of movement of the contact part 50 is large, it is possible to control the contact and non-contact of the contact part 50 and the spool 10.

In addition, the contact part 50 can be disposed on the other end of the main body portion 421. According to this configuration, the amount of movement of the contact part 50 can be further increased, and it is possible to control contact and non-contact of the contact part 50 and the spool 10.

In addition, the contact part 50 can have the abutting portion 51 that can abut against the spool 10, and the protruding portion 52 located further in the first direction D1 than the abutting portion 51 and protrudes further than the abutting portion 51, and the main body portion 421 can have the first retention portion 427 that can retain and position the protruding portion 52, and the second retention portion 428 located further in the second direction D2 than the first retention portion 427 and that can retain and position the protruding portion 52. According to this configuration, it is possible to prohibit execution of braking using frictional force when the contact part 50 is positioned at the first retention portion 427, and it is possible to execute braking using frictional force when the contact part 50 is positioned at the second retention portion 428. That is, since it is possible to use the retention positions to switch between braking in which frictional braking force is added to induction braking force and braking in which frictional force is not added, i.e., braking using only induction braking force, the braking force can be easily adjusted.

In addition, the abutting portion 51 can have a central portion in the circumferential direction and at an end in the second direction D2 that protrudes in the second direction D2. According to this configuration, since the abutting portion 51 has a central portion along the circumferential direction and at an end in the second direction D2 that protrudes in the second direction D2, the abutting portion 51 comes in surface contact with the spool 10. Accordingly, since the abutting portion 51 comes in surface contact with the inner circumferential surface of the spool 10, generation of an abnormal noise can be suppressed.

In addition, the abutting portion 51 of the contact part 50 positioned by the second retention portion 428 can protrude in the second direction D2 from the surface of the main body portion 421 in the second direction D2, and the protrusion amount of the abutting portion 51 in the second direction D2 can be set such that the abutting portion 51 does not contact the spool 10 when the spool 10 starts to rotate as the fishing line is pulled out, and the abutting portion 51 contacts the spool 10 as the rotation speed of the spool 10 increases. According to this configuration, it is possible to execute braking in which, in addition to the induction braking force of the magnet 33 facing the conductive part 32 provided on the spool 10, frictional braking force can be added as a result of the contact part 50 contacting the spool 10 when the movable part 42 is located at the second position P2.

An embodiment of the present disclosure has been described above with reference to the drawings. However, the present disclosure is not limited to the embodiment described above, and may be implemented in various forms within the scope of the spirit of the present disclosure. The drawings basically show each compositional element in a schematic manner for ease of understanding. The number, etc., of each of the illustrated compositional elements can be different from the actual number for the convenience of drawing preparation. In addition, compositional elements shown in the embodiment described above are examples and are not limiting, and various modifications may be made to the extent of not substantially departing from the effects of the present disclosure.

In the present embodiment, the movable part 42 swings in the radial direction of the cylindrical part 41 about the shaft portion 422, but the present disclosure is not limited thereto. The movable part 42 can be a movable part that moves in the radial direction by translational motion. FIG. 10 is a front view showing a modified example of the movable part 42 according to the first embodiment of the present disclosure. As shown in FIG. 10, a movable unit 40A has a movable part 42A. The movable part 42A has a main body portion 421A, a biasing portion (not shown), and a link mechanism 43.

The main body portion 421A is raised and lowered by the link mechanism 43. The main body portion 421A supports a plurality of the magnets 33 and a single contact part 50 on the radially outer side. Specifically, a single contact part 50 is disposed between two magnets 33 having different magnetic poles.

The link mechanism 43 has a pair of links 431. One of the links 431 connects the one end direction W1 end of the main body portion 421A and the cylindrical main body 411. The other link 431 connects the second end direction W2 end of the main body portion 421A and the cylindrical main body 411. The pair of links 431 and the main body portion 421A form a parallelogram-shaped link. The main body portion 421A when the pair of links 431 are lowered is positioned further in the first direction D1 than the main body portion 421A when the pair of links 431 are raised. The main body portion 421A when the pair of links 431 are raised is parallel to the main body portion 421A when the pair of links 431 are lowered.

When an induction force is not generated by the magnets 33, the biasing portion biases the pair of links 431 to be lowered. According to this configuration, the distance between each of the magnets 33 and the conductive part 32 is equal, so that the magnetic flux of the magnets 33 can be effectively used regardless of the circumferential positions of the magnets 33.

In the present embodiment, a pair of the movable parts 42 are provided, but the present disclosure is not limited thereto. The number of the movable parts 42 can be one, or three or more. In addition, the number of the magnets 33 and the number of the contact parts 50 can also be selected as appropriate in accordance with the required performance.

In the present embodiment, nothing is disposed between the protruding portion 52 and the main body portion 421, but the present disclosure is not limited thereto. A contact part biasing portion that biases the contact part 50 in the second direction D2 can be provided between the protruding portion 52 and the main body portion 421. In this case, the contact part biasing portion is set to have a lower biasing force than the biasing portion 424. As a result, the timing at which the frictional force acts is precisely controlled.

In the present embodiment, the contact part 50 is positioned and fixed by the first retention portion 427, the second retention portion 428, and the column portion 429, but the present disclosure is not limited thereto. A screw thread can be provided on the column portion 429 and a screw hole can be provided in the center of the contact part 50, to thereby omit the first retention portion 427 and the second retention portion 428. In this case, it is also possible to provide a slack prevention mechanism between the contact part 50 and the column portion 429.

A lubricating oil supply mechanism can be provided to supply lubricating oil to the inner circumferential surface of the spool 10. It is thereby possible to prevent generation of abnormal noise when the contact part 50 comes in contact with the spool 10.

(In the present embodiment, the retention position of the contact part 50 is manually changed between the first retention portion 427 and the second retention portion 428, but the present disclosure is not limited thereto. The retention position of the contact part 50 can be fixed to the retention position of the second retention portion 428. Alternatively, a switching device that switches the retention position may be provided to mechanically change the retention position of the contact part 50.

In the present embodiment, one end of the main body portion 421 in the circumferential direction is supported by the shaft portion 422 so as to be able to swing, and the other end in the circumferential direction is biased, but the present disclosure is not limited thereto. Without being limited to the circumferential direction, the main body portion 421 can be configured such that an intermediate portion is supported by the shaft portion 422 so as to be able to swing, and that the intermediate portion is biased.

A second embodiment of a fishing reel according to the present disclosure will be described below with reference to the drawings. Identical or corresponding parts in the drawings have been assigned the same reference numerals, and explanations thereof are not repeated.

### EMBODIMENT 1

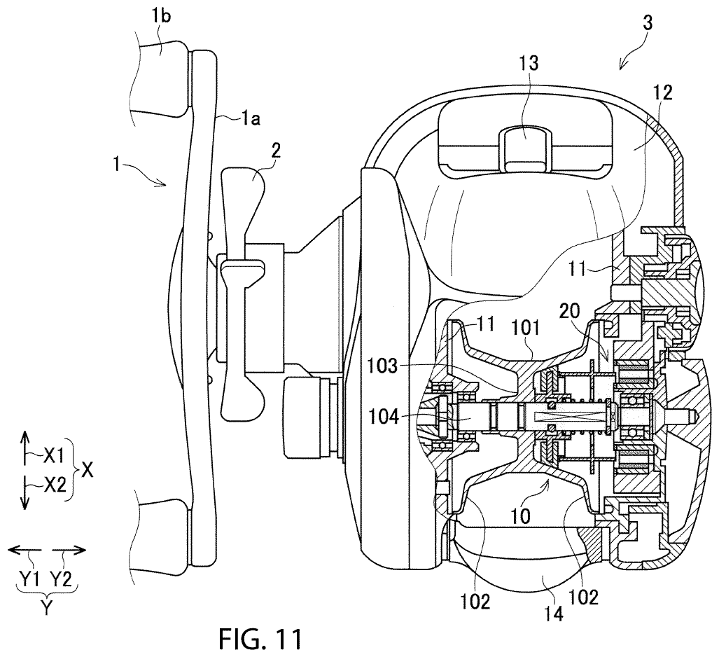

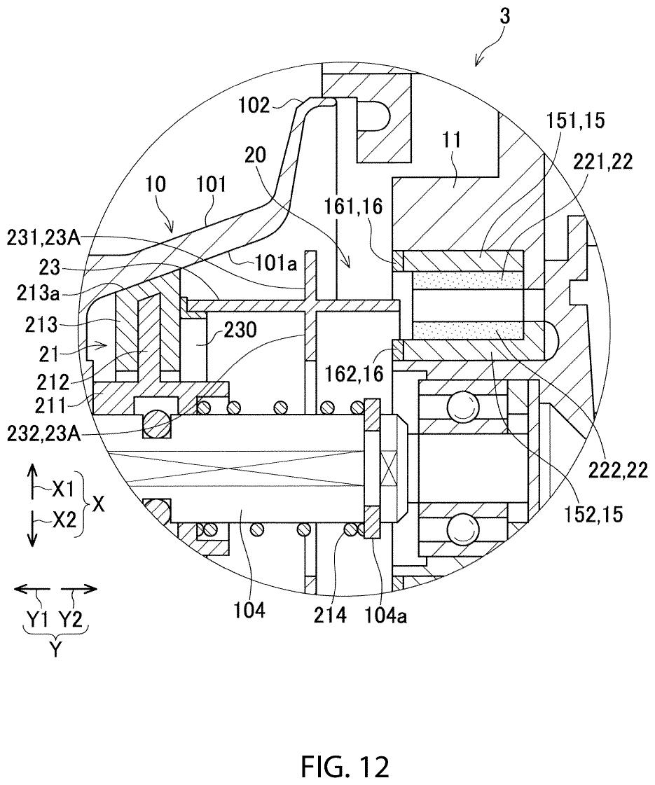

The underlying technology of the fishing reel according to one embodiment of the present disclosure will be described with reference to FIGS. 11 and 12. FIG. 11 is a schematic diagram showing a partial cross section of a fishing reel according to the second embodiment of the present disclosure. FIG. 12 is a cross-sectional view of the spool 10 and a braking device 20 in a non-braking state according to embodiment 1 of the second embodiment of the present disclosure. This fishing reel is, for example, a dual-bearing reel that is used mainly for lure fishing. As shown in FIG. 11, the fishing reel comprises a handle 1, a star drag 2, a reel body 3, and a braking device 20.

The handle 1 carries out an operation to wind the fishing line. The handle 1 is arranged on the side of the reel body 3. The handle 1 has a plate-shaped arm 1a having a rotational shaft in the center in the longitudinal direction, and a pair of grips 1b mounted to both ends of the arm 1a so as to be freely rotatable. When the handle 1 is turned, a spool 10 described further below is rotated, thereby winding up the fishing line.

The star drag 2 is adjusted so that a certain level or more tension will not be applied, so that the fishing line would not break when a fish, etc., is caught. The star drag 2 is arranged coaxially with the handle 1 and is positioned between the handle 1 and the reel body 3.

The reel body 3 is mounted on a fishing rod. The reel body 3 comprises the spool 10, a frame 11, a cover 12, a clutch operation lever 14, and a holding part 15. The reel body 3 further comprises, inter alia, a gear mechanism, a clutch mechanism, a drag mechanism, and a level winding mechanism 13.

The spool 10 is configured so as to be capable of winding up the fishing line. The spool 10 is provided to the reel body 3 so as to be rotatable about an axis. The spool 10 is, for example, made of an aluminum alloy, and is a non-magnetic electrical conductor. The material of the spool 10 is not limited to an aluminum alloy. The material of the spool 10 can be selected from various materials as long as the material is a non-magnetic electrical conductor. As shown in FIGS. 11 and 12, the spool 10 includes a body portion 101, a flange portion 102, a boss portion 103, and a spool shaft 104. The spool 10 is integrally formed of a tubular member that is provided on the spool shaft 104 and rotates about the axis.

A fishing line is wound around the outer circumferential portion of the body portion 101. The body portion 101 is formed substantially in a tubular shape. The inner diameter of the body portion 101 increases in a tapered manner from the axially central portion thereof toward the axially outer side. That is, a first tapered portion 101a is provided on the inner periphery of the body portion 101. The inner diameter of the inner periphery of the body portion 101 increases in a tapered manner, but the disclosure is not limited thereto. The inner periphery of the body portion 101 may have a curved shape as long as the inner diameter at least increases outward.

The flange portion 102 is provided at each of the two ends of the body portion 101. The pair of flange portions 102 respectively extend from both ends of the body portion 101 axially outward and radially outward. The boss portion 103 is integrally provided with the body portion 101 at the center of the body portion 101 in the axial direction. The boss portion 103 is formed in a tubular shape extending in the axial direction.

The spool shaft 104 is supported by the reel body so as to be rotatable. The spool shaft 104 is fixed to the boss portion 103 and rotates in synchronization with the body portion 101. The spool shaft 104 penetrates through the boss portion 103. The spool shaft 104 is fixed to the boss portion 103, for example by serration coupling or bonding, so as not to rotate relative to the body portion 101.

As shown in FIGS. 11 and 12, the frame 11 supports each component member, such as the handle 1 and the spool 10. As can be understood, a pair of the frames 11 are provided. The pair of frames 11 are plate-like members that are arranged facing each other across the spool 10 and are each perpendicular to the direction in which the spool shaft 104 extends. Hereinbelow, in a state in which the fishing reel is mounted on a fishing rod, the direction in which the tip of the fishing rod faces can be referred to as forward X1, the opposite direction can be referred to as rearward X2, and the front-rear direction can be referred to as X. The direction from the spool 10 toward the handle 1 can be referred to as leftward Y1, the opposite direction can be referred to as rightward Y2, and the left-right direction can be referred to as Y.

The cover 12 forms an outer wall of the reel body 3. The cover 12 has a thumb rest. The thumb rest is disposed so as to surround the periphery of the spool 10 except for rearward X2 of the spool 10.

The level winding mechanism 13 is a mechanism for evenly winding the fishing line around the spool 10. The level winding mechanism 13 moves in the left-right direction. The level winding mechanism 13 is disposed forward X1 of the spool 10 between the first frame 111 and the second frame 112.

The clutch operation lever 14 operates the clutch mechanism between the handle 1 and the spool 10. The clutch operation lever 14 is disposed rearward X2 of the spool 10, and is configured so as to be able to swing in the up-down direction. The clutch operation lever 14 has a thumb rest portion in the middle in the left-right direction Y to be used when carrying out thumbing.

The holding part 15 holds a magnetic part 22, described further below. The holding part 15 is disposed rightward Y2 of the spool 10 and is supported by the frame 11. The left side end of the holding part 15 is configured so as to be flush with the left side end of the frame 11. In addition, the holding part 15 is formed in a tubular shape and has the same axis as the spool shaft 104. The holding part 15 has a first holding portion 151, a second holding portion 152 located radially inward of the first holding portion 151, and a slider 16.

The slider 16 is a ring-shaped member made of a synthetic resin material having self-lubricating properties. The slider 16 can be made of material selected from polyacetal (POM), MC nylon, PTFE, UPE, and the like. The slider 16 corresponds to a brake shoe in brakes used in vehicles or the like. The slider 16 has a first slider 161 and a second slider 162.

The first slider 161 is disposed on the left side end of the first holding portion 151 and constitutes a portion of the first holding portion 151. The left side end of the first slider 161 is configured so as to be flush with the left side end of the frame 11. The first slider 161 can be expanded in the radial direction and be disposed at the left side end of the first holding portion 151 and the left side end of a portion of the frame 11. In addition, the left side end of the first slider 161 may protrude further to the left than the left side end of the frame 11.

The second slider 162 is disposed on the left side end of the second holding portion 152 and constitutes a portion of the second holding portion 152. The left side end of the second slider 162 is configured so as to be flush with the left side end of the frame 11. The second slider 162 can be expanded in the radial direction and be disposed at the left side end of the second holding portion 152 and the left side end of a portion of the frame 11. In addition, the left side end of the second slider 162 can protrude further to the left than the left side end of the frame 11.

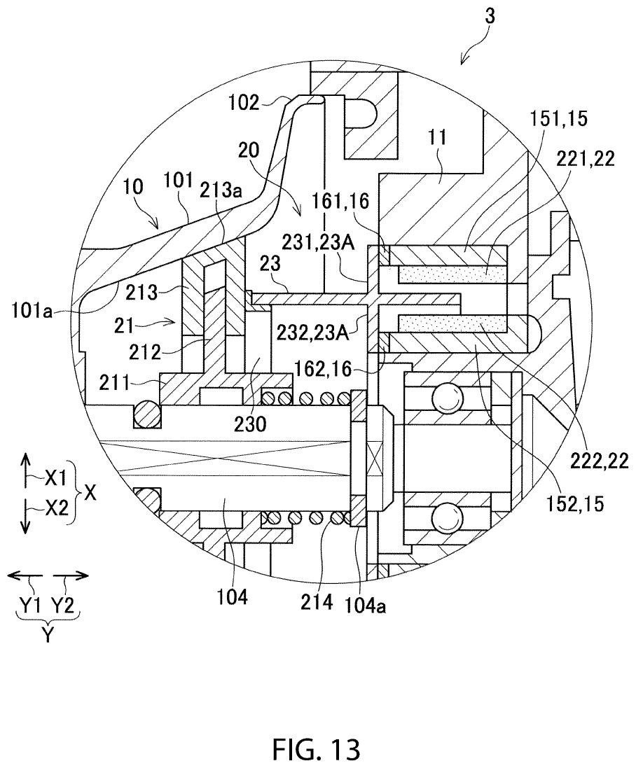

The braking device 20 will be described next with reference to FIGS. 12 and 13. FIG. 13 is a cross-sectional view of the spool 10 and the braking device 20 in a frictional force braking state according to embodiment 1 of the second embodiment of the present disclosure. The frictional force braking state is a state in which braking is executed using contact frictional force. As shown in FIGS. 12 and 13, the braking device 20 has a movable part 21, a magnetic part 22, and a conductive part 23.

The movable part 21 moves in the axial direction of the spool shaft 104 in accordance with the rotational speed of the spool 10. The movable part 21 is provided on the spool 104 and integrally rotates in synchronization with the spool 10. The centrifugal force increases as the rotational speed of the spool 10 increases, and therefore the amount of movement of the movable part 21 increases. The movable part 21 is located between the inner periphery of the spool 10 and the spool shaft 104. The movable part 21 includes a moving main body portion 211, a support portion 212, a guide portion 213, and a biasing portion 214.

The moving main body portion 211 supports the support portion 212 and the guide portion 213. The moving main body portion 211 is formed substantially in a tubular shape, and the spool shaft 104 is inserted therethrough. For example, the moving main body portion 211 slides on the outer circumferential surface of the spool shaft 104 in the left-right direction Y, from the axial center to the axial end of the spool 10. The moving main body portion 211 can be integrally formed with the support portion 212.

The support portion 212 supports the guide portion 213. The support portion 212 extends radially outward from the middle portion of the moving main body portion 211 in the left-right direction Y. The radially outer side end portion of the support portion 212 is spaced apart from the inner periphery of the spool 10 (first tapered portion 101a) in the radial direction.

The guide portion 213 is formed so as to be movable in the radial direction, guided by the support portion 212. The guide portion 213 is prevented from rotating in the circumferential direction with respect to the support portion 212. The guide portion 213 is held so as to cover the support portion 212 from the radially outer side, so that the overlapping region with the support portion 212 decreases when moved in the radially outward direction, and the overlapping region with the support portion 212 increases when moved in the radially inward direction. The guide portion 213 is preferably made of a synthetic resin material having self-lubricating properties, for example. It is thereby possible to suppress the generation of abnormal noise while exhibiting frictional force. The guide portion 213 can be made of material selected from polyacetal (POM), MC nylon, PTFE, UPE, and the like. The guide portion 213 has a second tapered portion 213a.

The second tapered portion 213a is provided at the radially outer side end portion of the guide portion 213, facing the inner periphery (first tapered portion 101a) of the spool 10. Specifically, the second tapered portion 213a is inclined along the axial direction of the spool 10, and is curved along the circumferential direction of the spool 10. That is, the second tapered portion 213a is formed so as to be slidable in surface contact with the first tapered portion 101a. As a result, the second tapered portion 213a converts the force that acts on the guide portion 213 in the radially outward direction to a force in the axial direction directed rightward Y2.

The biasing portion 214 biases the moving main body portion 211 toward the axial center of the spool 10. The spool shaft 104 is inserted into the biasing portion 214. The left end of the biasing portion 214 abuts against the right end of the moving main body portion 211, and the right end of the biasing portion 214 abuts against a retaining portion 104a. The retaining portion 104a is supported by a groove portion of the spool shaft 104, for example.

The magnetic part 22 has magnetic force. The magnetic part 22 is formed as a tubular body having the same axis as the axis of the spool 10. The magnetic part 22 is provided in the reel body 3. Specifically, the magnetic part 22 is disposed rightward Y2 of the spool 10 and is held by the holding part 15 from the radial direction. The magnetic part 22 has a first magnet portion 221 and a second magnet portion 222.

The first magnet portion 221 is located on the outer side of the conductive part 23 in the radial direction of the spool 10. The first magnet portion 221 is a ring-shaped magnet in which the S pole and the N pole, which orient the magnetic field in the radial direction, are alternately magnetized along the circumferential direction. The first magnet portion 221 is held by the first holding portion 151. Specifically, the first magnet portion 221 is surrounded by the first holding portion 151 whose radially outer side portion is supported by the frame 11. The left side end of the first magnet portion 221 is located to the right of the left side end of the first slider 161 (first holding portion 151).

The second magnet portion 222 is located on the inner side of the conductive part 23 in the radial direction of the spool 10. The second magnet portion 222 is a ring-shaped magnet in which the S pole and the N pole, which orient the magnetic field in the radial direction, are alternately magnetized along the circumferential direction. The second magnet portion 222 is disposed facing the first magnet portion 221 with the magnetic poles being opposite to each other. The left side end of the second magnet portion 222 is set at the same position as the left side end of the first magnet portion 221 in the axial direction of the spool 10. The second magnet portion 222 is held by the second holding portion 152. Specifically, the second magnet portion 222 is surrounded by the second holding portion 152 whose radially inner side portion is supported by the frame 11. The left side end of the second magnet portion 222 is located to the right of the left side end of the second slider 162 (second holding portion 152). The magnetic pole of the first magnet portion 221 and the magnetic pole of the second magnet portion 222 are opposed to each other in a reversed manner, but the disclosure is not limited thereto. Either the first magnet portion 221 or the second magnet portion 222 may be configured so as to be rotatable in the circumferential direction, and the braking force may be adjusted by shifting the phases of the two.

The conductive part 23 is provided on the movable part 21 and moves together with the movable part 21. The conductive part 23 moves toward or away from the magnetic part 22 in accordance with the rotational speed of the spool 10. The conductive part 23 is formed in a tubular shape having the same axis as the axis of the spool 10. Specifically, the conductive part 23 has a small diameter than the first magnet portion 221 and a larger diameter than the second magnet portion 222. The conductive part 23 rotates integrally with the spool 10, and as the rotational speed of the spool 10 increases, the amount of entry into the magnetic field formed by the magnetic part 22 increases. If the spool 10 is not rotating, the conductive part 23 does not enter into the magnetic field formed by the magnetic part 22. The conductive part 23 is made of a non-magnetic conductive material, such as aluminum or copper. The conductive part 23 has a connecting portion 230 and a contact part 23A.

The connecting portion 230 connects the conductive part 23 to the moving main body portion 211. The connecting portion 230 extends radially outward from the moving main body portion 211, at a position that is axially outward (rightward Y2) of the support portion 212. The connecting portion 230 supports the inner side end of the conductive part 23 in the axial direction, at the radially outer side portion. As a result, the connecting portion 230 maintains the orientation of the conductive part 23 extending axially outward (rightward Y2) from the connecting portion 230.

The contact part 23A is formed so as to be able to come in contact with a contacting part. The contacting part is provided in the reel body 3 (refer to FIG. 11). For example, at least one of the frame 11, the holding part 15, and the magnetic part 22 corresponds to the contacting part. In the present embodiment, the holding part 15 corresponds to the “contacting part.” Specifically, the first slider 161 constituting a portion of the first holding portion 151 and the second slider 162 constituting a portion of the second holding portion 152 respectively correspond to the “contacting part.” The contact part 23A is provided on the movable part 21 and moves together with the movable part 21. Specifically, the contact part 23A is formed integrally with the conductive part 23. The contact part 23A has a first contact portion 231 and a second contact portion 232. For example, the contact part 23A corresponds to a brake disk in brakes used in vehicles or the like.

The first contact portion 231 comes into surface contact with the first slider 161. The first contact portion 231 is an annular plate portion. The first contact portion 231 extends radially outward from an intermediate portion of the conductive part 23 in the axial direction. The radially outer side end portion of the first contact portion 231 is located radially inward of the radially outer side end portion of the first slider 161. When the amount by which the conductive part 23 attempts to enter into the magnetic field of the magnetic part 22 is greater than or equal to a prescribed value, the first contact portion 231 abuts against the first slider 161 to generate a frictional braking force. The magnetic field of the magnetic part 22 approximates a space formed by the first magnet portion 221 and the second magnet portion 222 facing each other.

The second contact portion 232 comes into surface contact with the second slider 162. The second contact portion 232 is an annular plate portion. The radially inner side end portion of the second contact portion 232 is located radially outward of the radially inner side end portion of the second slider 162. The second contact portion 232 extends radially inward from an intermediate portion of the conductive part 23 in the axial direction, corresponding to the first contact portion 231. Thus, the timing at which the second contact portion 232 abuts against the second slider 162 is the same as the timing at which the first contact portion 231 abuts against the first slider 161. Hereinbelow, a state in which that conductive part 23 has not entered into the magnetic field of the magnetic part 22 may be referred to as a non-braking state, a state in which the conductive part 23 has entered into the magnetic field of the magnetic part 22 but the amount of entry is less than a prescribed value so that the contact part 23A is not in contact with the slider 16 may be referred to as an induction force braking state, and a state in which the conductive part 23 has entered into the magnetic field of the magnetic part 22 and the contact part 23A is in contact with the slider 16 may be referred to as a frictional force braking state.

The operation of the braking device 20 will be described next. As shown in FIG. 12, a state in which the spool 10 is not rotating is a non-braking state, and a radially outward centrifugal force does not act on the movable part 21. Since centrifugal force does not act on the movable part 21, the moving main body portion 211 is pressed axially inward (leftward Y1) by the biasing force of the biasing portion 214. When in the non-braking state, the conductive part 23, the first contact portion 231, and the second contact portion 232 are spaced apart from the magnetic field of the magnetic part 22. The conductive part 23 is essentially not affected by the magnetic field of the magnetic part 22.

When the spool 10 starts to rotate due to a casting operation, a radially outward centrifugal force acts on the movable part 21. Since centrifugal force acts on the movable part 21, the guide portion 213 is moved radially outward along the support portion 212, and the second tapered portion 213a is pressed by the first tapered portion 101a of the body portion 101. The guide portion 213 converts the radially outward force that acts on the movable part 21 to an axially outward (rightward Y2 side) force. The moving main body portion 211 moves to a position at which the axially outward force converted from the centrifugal force, and the biasing force of the biasing portion 214 are balanced. As a result, the conductive part 23 enters into the magnetic field of the magnetic part 22. An eddy current corresponding to the rotation speed of the spool 10 is generated due to the magnetic flux of the magnetic part 22 that faces the conductive part 23. The eddy current causes induction force to act on the spool 10 in the direction opposite to the rotation direction, thereby exhibiting an induction force braking function. The induction force braking function is a function in which induction force resulting from an eddy current caused by magnetic force is caused to act on the spool 10 as braking force in the direction opposite to the rotation direction of the spool 10.

As shown in FIG. 13, when the rotational speed of the spool 10 increases further and the centrifugal force acting on the movable part 21 increases, the amount by which the conductive part 23 attempts to enter into the magnetic field of the magnetic part 22 increases to a prescribed value or more. Since a large centrifugal force acts on the movable part 21, the moving main body portion 211 moves further axially outward against the biasing portion 214. The movement of the moving main body portion 211 increases the eddy current, and as the eddy current increases the induction force also increases. In addition, since the amount of by which the conductive part 23 attempts to enter into the magnetic field of the magnetic part 22 is greater than or equal to a prescribed value, the contact part 23A comes in contact with the slider 16. Contact frictional force is generated between the contact part 23A and the slider 16, thereby exhibiting a frictional force braking function. As a result, induction force and frictional force act on the spool 10 as braking force. The frictional force braking function is a function in which frictional force that is generated when the contact part 23A comes in contact with the slider 16 (holding part 15), which is the contacting part, is caused to act on the spool 10 as braking force.

On the other hand, when the rotational speed of the spool 10 decreases, the centrifugal force acting on the movable part 21 decreases. As the centrifugal force decreases, the force acting in the axially outward direction decreases, and the moving main body portion 211 moves axially inward. As a result, the contact part 23A is separated from the slider 16 and the conductive part 23 retreats from the magnetic field of the magnetic part 22.

According to the configuration described above, because the movable part 21 that moves in the axial direction of the spool shaft 104 in accordance with the rotational speed of the spool 10, the conductive part 23 that moves together with the movable part 21 so as to be capable of moving toward and away from the magnetic part 22, and the contact part 23 A that moves together with the movable part 21 so as to be capable of contacting the slider 16 (holding part 15), which is a contacting part provided on the reel body 3, are provided, it is possible to cause the induction force resulting from an eddy current caused by magnetic force to act on the spool 10, immediately after a casting operation. When the rotational speed of the spool 10 increases further, the movable part 21 approaches the magnetic part 22 due to the centrifugal force of the spool 10, and the contact part 23A comes in contact with the slider 16. That is, the braking device 20 applies, to the spool 10, a frictional force braking, which is contact braking in which there is contact with the spool 10, in addition to induction force braking, which is non-contact braking in which there is no contact with the spool 10. Accordingly, since braking using induction force and frictional force can be executed with respect to the spool 10, it is possible to suppress backlash.

In addition, the reel body 3 is configured to include the holding part 15 that holds the magnetic part 22. The holding part 15 has the slider 16 that contacts the contact part 23A. As a result, the contacting part that contacts the contact part 23A can also serve as the holding part 15 which is a part of the reel body 3 that holds the magnetic part 22, thereby reducing weight and size of the device.

In addition, the holding part 15, which is a contacting part, has the slider 16. According to the configuration, the contact part 23A and the holding part 15 are pressed via the slider 16, so that generation of an abnormal noise can be suppressed during frictional force braking.

In addition, the holding part 15 has a first holding portion 151 that holds the first magnet portion 221 located on the outer side of the conductive part 23 in the radial direction of the spool 10, and the second holding portion 152 that holds the second magnet portion 222 located on the inner side of the conductive part 23 in the radial direction of the spool 10 and faces the first magnet portion 221, and the contact part 23A has the first contact portion 231 that can contact the first holding portion 151, and the second contact portion 232 that can contact the second holding portion 152. According to this configuration, the contact part 23A has the first contact portion 231 that can contact the first holding portion 151 and the second contact portion 232 that can contact the second holding portion 152, so that the contact area between the contact part 23A and the contacting part can be increased compared to a case in which the contact part 23A is a single structure. That is, since the contact area between the contact part 23A and the contacting part can be increased, the frictional force generated between the contact part 23 A and the contacting part can be increased. Accordingly, since the frictional force can be increased, occurrence of backlash of the fishing reel can be further suppressed.

### EMBODIMENT 2

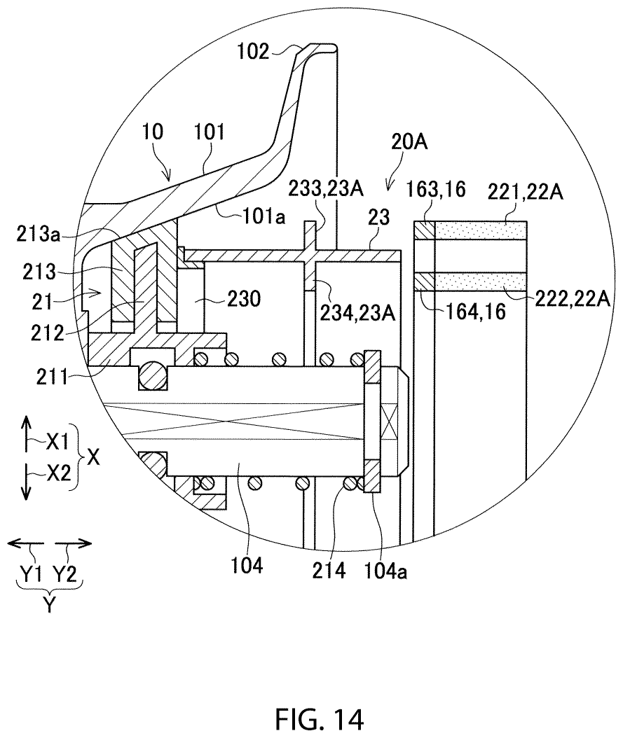

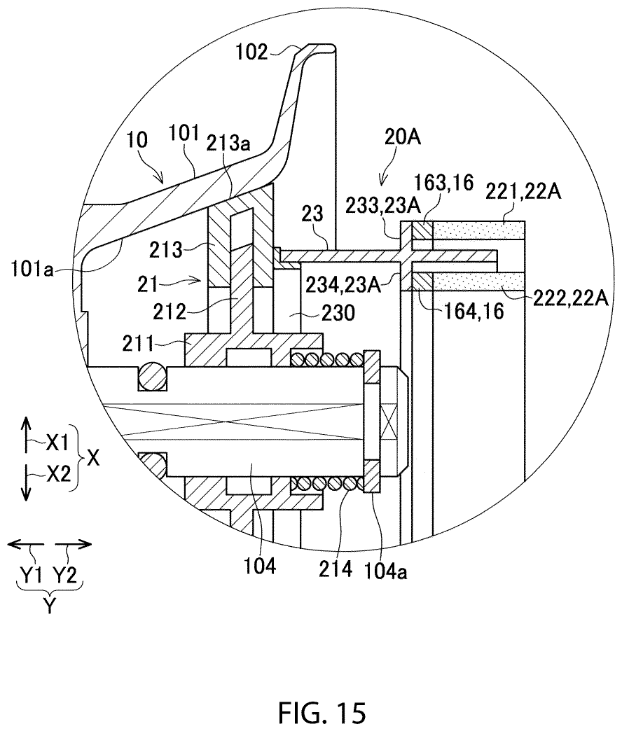

Embodiment 2 of the braking device 20 will be described next, with reference to FIGS. 14 and 15. Embodiment 2 is mainly different from embodiment 1 in that the contacting part is not the holding part 15 that constitutes a part of the reel body 3, but is the magnetic part 22A. The differences between embodiment 2 and embodiment 1 will be described below. The various modified examples described below are basically the same as those in embodiment 1 described above, and thus similar portions are assigned similar reference symbols, and detailed descriptions thereof are omitted.

FIG. 14 is a diagram of a braking device 20A in a non-braking state according to embodiment 2 of the second embodiment of the present disclosure. FIG. 15 is a diagram showing the braking device 20A in a frictional force braking state according to embodiment 2 of the second embodiment of the present disclosure. As shown in FIGS. 14 and 15, the braking device 20A has a movable part 21, a magnetic part 22A, and a conductive part 23.

The magnetic part 22A corresponds to, for example, the “contacting part.” The magnetic part 22A has a first magnet portion 221, a second magnet portion 222, and a slider 16. The slider 16 has a third slider 163 and a fourth slider 164.

The third slider 163 is disposed on the left side end of the first magnet portion 221 and constitutes a portion of the first magnet portion 221. The radial width of the third slider 163 is set to be the same as the radial width of the first magnet portion 221. The third slider 163 can be expanded in the radial direction and be disposed at, in addition to the left side end of the first magnet portion 221, the left side end of a portion of the frame 11.

The fourth slider 164 is disposed on the left side end of the second magnet portion 222 and constitutes a portion of the second magnet portion 222. The radial width of the fourth slider 164 is set to be the same as the radial width of the second magnet portion 222. The fourth slider 164 can be expanded in the radial direction and be disposed at, in addition to the left side end of the second magnet portion 222, the left side end of a portion of the frame 11.

The conductive part 23 has a contact part 23A. The contact part 23A is formed integrally with the conductive part 23. The contact part 23A has a third contact portion 233 and a fourth contact portion 234.

The third contact portion 233 contacts the third slider 163. The third contact portion 233 is an annular plate portion. The third contact portion 233 extends radially outward from an intermediate portion of the conductive part 23 in the axial direction. The radially outer side end portion of the third contact portion 233 is located at a radial position where it is possible to abut against the left surface of the third slider 163. When the amount by which the conductive part 23 attempts to enter into the magnetic field of the magnetic part 22 is greater than or equal to a prescribed value, the third contact portion 233 abuts against the left surface of the third slider 163 to generate a frictional braking force.

The fourth contact portion 234 comes into surface contact with the fourth slider 164. The fourth contact portion 234 is an annular plate portion. The radially inner side end portion of the fourth contact portion 234 is located at a radial position where it is possible to abut against the left surface of the fourth slider 164. The fourth contact portion 234 extends radially inward from an intermediate portion of the conductive part 23 in the axial direction, corresponding to the third contact portion 233. Thus, the timing at which the fourth contact portion 234 abuts against the fourth slider 164 is the same as the timing at which the third contact portion 233 abuts against the third slider 163.

According to the configuration described above, when the amount by which the conductive part 23 attempts to enter into the magnetic field of the magnetic part 22A increases to a prescribed value or greater, in addition to the induction force braking, the third contact portion 233 and the fourth contact portion 234 respectively come in contact with the third slider 163 and the fourth slider 164, thereby exhibiting a frictional force braking function. Moreover, as a result of integrating the slider 16 and the magnetic part 22A, it is possible to dispose the third slider 163 (fourth slider 164) in the dead space that is formed between the left side end of the first holding portion 151 (second holding portion 152) and the left side end of the first magnet portion 221 (second magnet portion 222). As a result, it is possible to use the dead space that is created by the arrangement of the magnetic part 22, thereby making it possible to reduce the size of the braking device 20A.

### EMBODIMENT 3

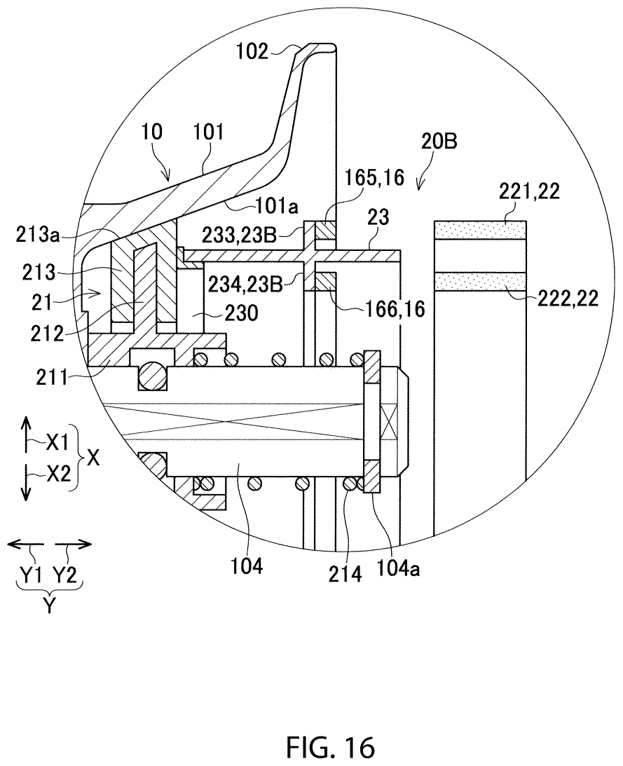

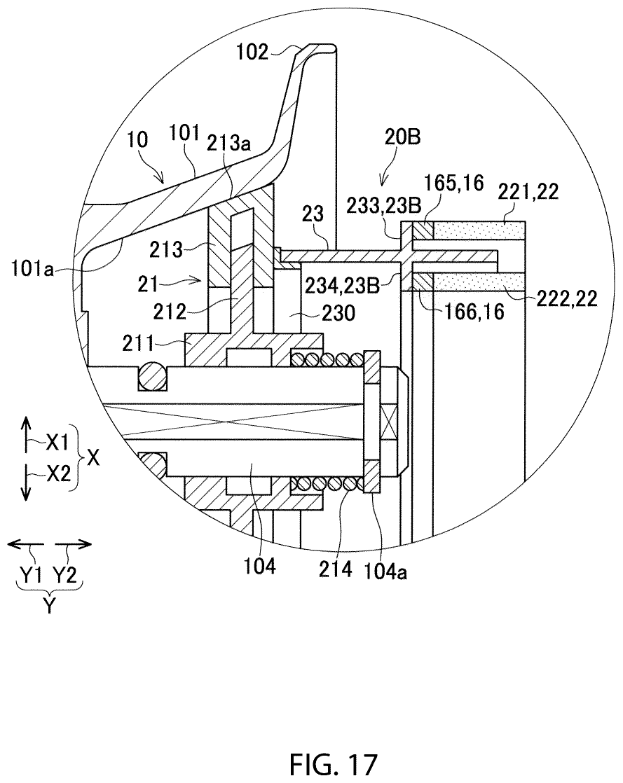

Embodiment 3 of the braking device 20 will be described next, with reference to FIGS. 16 and 17. Embodiment 3 is different from embodiments 1 and 2 basically in that the slider 16 is attached to the contact part 23A. The differences between embodiment 3 and embodiments 1 and 2 will be described below.

FIG. 16 is a diagram of a braking device 20B in a non-braking state according to embodiment 3 of the second embodiment of the present disclosure. FIG. 17 is a diagram showing the braking device 20B in a frictional force braking state according to embodiment 3 of the second embodiment of the present disclosure. As shown in FIGS. 16 and 17, the braking device 20B has a movable part 21, a magnetic part 22, and a conductive part 23.

The magnetic part 22 corresponds to, for example, the “contacting part.” The magnetic part 22 has a first magnet portion 221 and a second magnet portion 222.

The conductive part 23 has a contact part 23B. The contact part 23B is integrally formed with the conductive part 23. The contact part 23B has a third contact portion 233, a fourth contact portion 234, and a slider 16. The slider 16 has a fifth slider 165 and a sixth slider 166. The fifth slider 165 and the sixth slider 166 are formed in a ring shape.

The third contact portion 233 contacts the first magnet portion 221. The third contact portion 233 has the fifth slider 165. The fifth slider 165 is located on the right side and the radially outer side end portion of the third contact portion 233.

The fourth contact portion 234 contacts the second magnet portion 222. The fourth contact portion 234 has the sixth slider 166. The sixth slider 166 is located on the right side and the radially inner side end portion of the fourth contact portion 234.

According to the configuration described above, when the amount by which the conductive part 23 attempts to enter into the magnetic field of the magnetic part 22 increases to a prescribed value or greater, in addition to the induction force braking, the fifth slider 165 and the sixth slider 166 respectively come in contact with the first magnet portion 221 and the second magnet portion 222, thereby exhibiting a frictional force braking function. Moreover, since the slider 16 is fixed to the spool 10 side, the moment of inertia of the movable part 21 can be increased when operating the braking device 20B, and the centrifugal force of the spool 10 can be increased earlier.

### EMBODIMENT 4

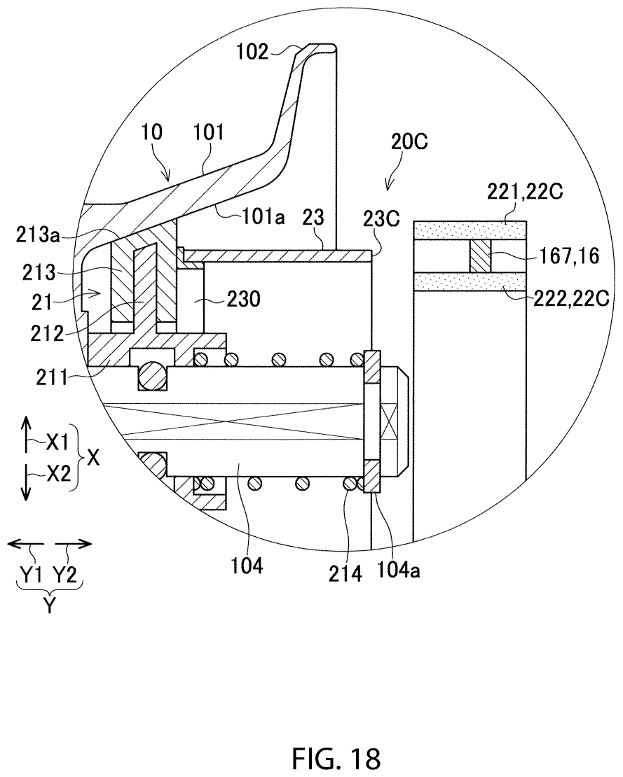

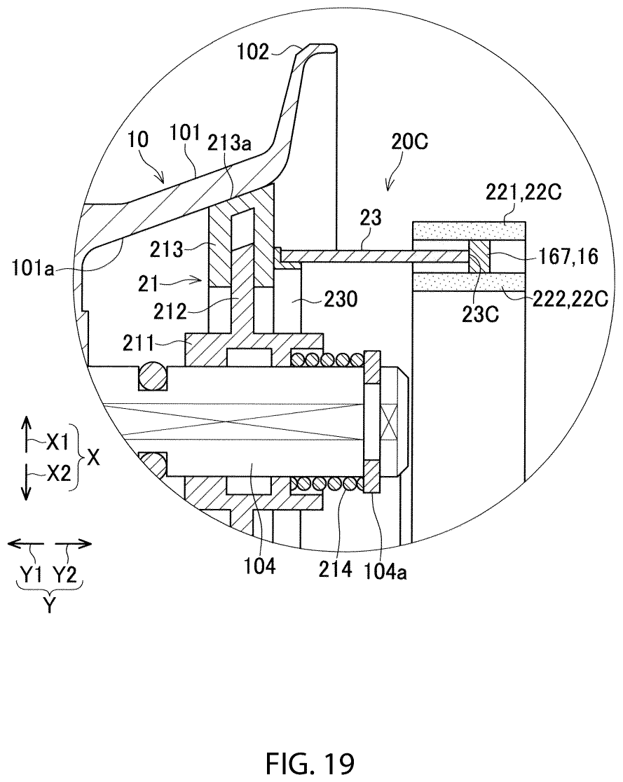

Embodiment 4 of the braking device 20 will be described next, with reference to FIGS. 18 and 19. Embodiment 4 is different from the other embodiments mainly in that the slider 16 is disposed between the first magnet portion 221 and the second magnet portion 222. The differences between embodiment 4 and the other embodiments will be described below.

FIG. 18 is a diagram of a braking device 20C in a non-braking state according to embodiment 4 of the second embodiment of the present disclosure. FIG. 19 is a diagram showing the braking device 20C in a frictional force braking state according to embodiment 4 of the second embodiment of the present disclosure. As shown in FIGS. 18 and 19, the braking device 20C has a movable part 21, a magnetic part 22, and a conductive part 23.

The magnetic part 22C corresponds to, for example, the “contacting part.” The magnetic part 22C has a first magnet portion 221, a second magnet portion 222, and a slider 16. The slider 16 includes a seventh slider 167.

The seventh slider 167 is disposed between the first magnet portion 221 and the second magnet portion 222. Specifically, the seventh slider 167 is fixed to an intermediate portion of the magnetic part 22C in the axial direction. The seventh slider 167 is formed of an annular member that is substantially perpendicular to the left-right direction Y.

The conductive part 23 has a contact part 23C. The contact part 23C is formed integrally with the conductive part 23. The contact part 23C is located on the right side end of the conductive part 23. When the amount of by which the conductive part 23 attempts to enter into the magnetic field of the magnetic part 22 becomes greater than or equal to a prescribed value, the contact part 23C comes in contact with the seventh slider 167.

According to the configuration described above, when the amount by which the conductive part 23 attempts to enter into the magnetic field of the magnetic part 22 increases to a prescribed value or greater, in addition to the induction force braking, the contact part 23C comes in contact with the seventh slider 167, thereby exhibiting a frictional force braking function. Moreover, is it not necessary to separately provide a contact part that extends radially from the conductive part 23, which simplifies the components, and it becomes possible to reduce the size and weight of the device.

An embodiment of the present disclosure has been described above with reference to the drawings. However, the present disclosure is not limited to the embodiment described above, and may be implemented in various forms within the scope of the spirit of the present disclosure. The drawings may mainly show each compositional element in a schematic manner for ease of understanding. The number, etc., of each of the illustrated compositional elements may be different from the actual number for the convenience of drawing preparation. In addition, compositional elements shown in the embodiment described above are examples and are not limiting, and various modifications may be made to the extent of not substantially departing from the effects of the present disclosure.

In the present embodiment, the contact part 23A Extends in the radial direction from the conductive part 23, but the present disclosure is not limited thereto. The contact part 23A only needs to be in a state of contacting the magnetic part 22 only when frictional force is required. Accordingly, the contact part 23A can be configured to be switchable between an raised state in which it is possible to contact the magnetic part 22, and a lowered state in which it is not possible to contact the magnetic part 22. Specifically, a bendable hinge is provided in the intermediate portion of the contact part 23A in the radial direction. As a result, the contact part 23A can be switched between a first position in which the contact part 23A extends in the radial direction and is in contact with the magnetic part 22, and a second position in which the contact part 23A bends in a direction intersecting the radial direction and is not in contact with the magnetic part 22. Accordingly, since it is possible to switch between using and not using frictional braking force, the desired braking properties can be achieved in accordance with the use conditions, even if the rotational speed of the spool is the same. Furthermore, a switching mechanism may be provided that freely switches the position of the contact part 23A between the first position and the second position.

In the present embodiment, the magnetic part 22 has the first magnet portion 221 and the second magnet portion 222, but the present disclosure is not limited thereto. Since the braking device is only required to be able to execute induction force braking and frictional force braking, the magnetic part 22 may be a single magnet portion. In this case, a slider may be disposed in place of the magnet portion that is omitted. As a result, it is possible to suppress generation of abnormal noise during braking, while increasing the braking force.

In the present embodiment, the conductive part 23 is supported by the moving main body portion 211 via the connecting portion 230, but the present disclosure is not limited thereto. The conductive part 23 only needs to be able to advance and retract along the axial direction on the basis of the centrifugal force caused by the rotational speed of the spool 10. The conductive part 23 may be supported by the support portion 212, or supported by the guide portion 213, for example.

In the present embodiment, the contact part 23A contacts the slider 16, but the present disclosure is not limited thereto. The contact part 23 A only needs to be able to come in contact with the contacting part provided in the reel body 3, and the slider 16 can be omitted and the contact part 23A can contact the frame 11 or the holding part 15.

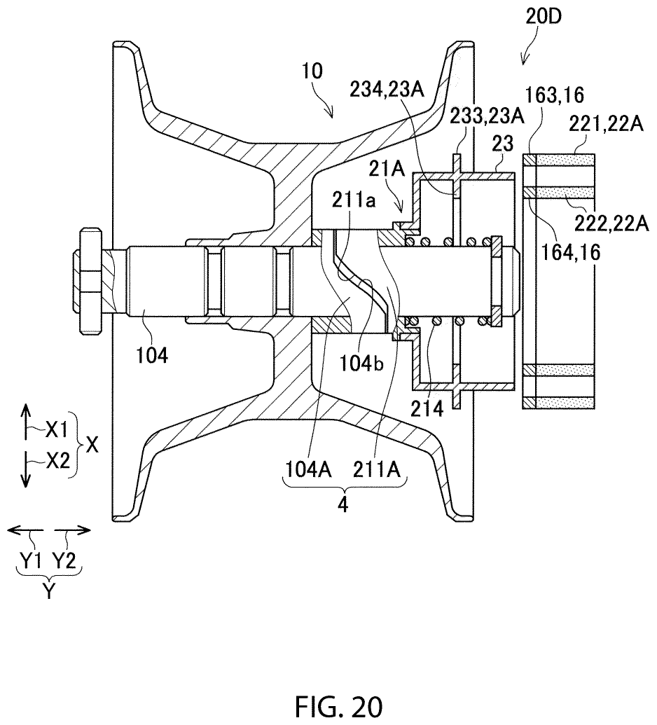

In the present embodiment, the conductive part 23 advances and retracts along the axial direction on the basis of the centrifugal force caused by the rotational speed of the spool 10, but the present disclosure is not limited thereto. For example, as shown in FIG. 20, a cam surface can be formed to move the conductive part 23 in the axial direction when the spool 10 rotates. A specific description will be given below with reference to FIG. 20. Since the configuration is basically the same as that of embodiment 2 described above, similar portions are assigned similar reference symbols, and detailed descriptions thereof are omitted.

As shown in FIG. 20, a braking device 20D has a cam part 4. The cam part 4 has a fixed cam portion 104A and a movable cam portion 211A. The fixed cam portion 104A is formed so as to be integrally rotatable with the spool shaft 104, and has a fixed cam surface 104b with an inclined shape facing the axially outer side. The movable cam portion 211A is formed so as to be movable in the axial direction of the spool shaft 104, and has a movable cam surface 211a with an inclined shape facing the axially inward side. When the rotational speed of the spool 10 is low, the fixed cam surface 104b and the movable cam surface 211a become essentially parallel and are in surface contact with each other so that the movable cam portion 211A is located leftward Y1. When the rotational speed of the spool 10 increases, the component force of the fixed cam surface 104b acting axially outward of the movable cam surface 211a increases. When the axial component force of the fixed cam surface 104b becomes larger than the biasing force of the biasing portion 214, the opposing state between the fixed cam surface 104b and the movable cam surface 211a changes, and the movable cam portion 211A is pressed by the fixed cam portion 104A and moves rightward Y2. By appropriately setting the inclination angle of the fixed cam surface 104b and the movable cam surface 211a, the timing at which the frictional force braking is exhibited can be adjusted.

1. A fishing reel comprising:
a reel body;
a spool provided on a reel body so as to be rotatable and configured to wind up a fishing line; and
a braking device configured to brake rotation of the spool,
the braking device including a magnetic induction braking function, and
a contact friction braking function.

2. The fishing reel according to claim 1, wherein
the braking device has
a conductive part provided on the spool,
a magnet facing the conductive part,
a movable part holding the magnet so as to be movable between a first position located in a first direction that is a direction away from the conductive part, and a second position located in a second direction that is a direction opposite to the first direction with respect to the conductive part, the second position being farther in the second direction than the first position is in the first direction, the movable part movable between the first position and the second position in accordance with rotation of the spool, and
a contact part provided on the movable part and configured to contact the spool when the movable part is located at the second position.

3. The fishing reel according to claim 1, wherein
the braking device has
a magnetic part having a magnetic force and provided in the reel body,
a movable part provided on the spool shaft and configured to move in the axial direction of the spool shaft in accordance with a rotational speed of the spool,
a conductive part provided on the movable part and configured to move together with the movable part so as to be capable of moving toward and away from the magnetic part, and
a contact part provided on the movable part and configured to move together with the movable part so as to be capable of coming into contact with a contacting part provided on the reel body.

4. A fishing reel, comprising:
a spool provided on a reel body so as to be rotatable and configured to wind up a fishing line; and
a conductive part provided on the spool,
a magnet facing the conductive part,
a movable part holding the magnet so as to be movable between a first position located in a first direction that is a direction away from the conductive part, and a second position located in a second direction that is a direction opposite to the first direction with respect to the conductive part, the second position being farther in the second direction than the first position is in the first direction, the movable part movable between the first position and the second position in accordance with rotation of the spool, and
a contact part provided on the movable part and configured to contact the spool when the movable part is located at the second position.

5. The fishing reel according to claim 4, wherein
the movable part has
a shaft portion extending along the axial direction of the conductive part,
a main body having a first end that is pivotably supported by the shaft portion and supporting a plurality of the magnets, and
a biasing portion configured to bias a second end of the main body in the first direction, and
the contact part is disposed closer to the second end than to at least one of the magnets.

6. The fishing reel according to claim 5, wherein
the contact part is disposed on the second end of the main body.

7. The fishing reel according to claim 2, wherein
the contact part has
an abutting portion configured to abut against the spool, and
a protruding portion located farther in the first direction than the abutting portion and protrudes farther than the abutting portion, and
the main body has
a first retention portion configured to retain and position the protruding portion, and
a second retention portion located further in the second direction than the first retention portion and configured to retain and position the protruding portion.

8. The fishing reel according to claim 7, wherein the abutting portion has a central portion along a circumferential direction of the spool and at an end in the second direction that protrudes in the second direction.

9. The fishing reel according to claim 7, wherein
the abutting portion of the contact part positioned by the second retention portion protrudes in the second direction from the surface of the main body in the second direction, and
a protrusion amount of the abutting portion in the second direction is such that the abutting portion does not contact the spool when the spool starts to rotate as fishing line is pulled out, and the abutting portion is configured to contact the spool as the rotation speed of the spool increases.

10. A fishing reel comprising:
a spool shaft supported by a reel body so as to be rotatable;
a spool provided on the spool shaft and configured to wind up a fishing line;
a magnetic part having a magnetic force and provided in the reel body;
a movable part provided on the spool shaft and movable in an axial direction of the spool shaft in accordance with a rotational speed of the spool;
a conductive part provided on the movable part and configured to move together with the movable part so as to be capable of moving toward and away from the magnetic part; and
a contact part provided on the movable part and configured to move together with the movable part so as to be capable of contacting a contacting part provided on the reel body.

11. The fishing reel according to claim 10, wherein
the reel body includes a holding part that holds the magnetic part, and
the holding part has the contacting part that is configured to contact the contact part.

12. The fishing reel according to claim 10 wherein
the contact part or the contacting part has a slider.

13. The fishing reel according to claim 11, wherein
the holding part has
a first holding portion holding a first magnet portion located on an outer side of the conductive part in a radial direction of the spool, and
a second holding portion holding a second magnet portion located on an inner side of the conductive part in the radial direction of the spool and faces the first magnet portion, and
the contact part has
a first contact portion configured to contact the first holding portion, and
a second contact portion configured to contact the second holding portion.
